(19) United States
(12) Patent Application Publication
(10) Pub. No.: US 2014/0058717 A1
(43) Pub. Date: Feb. 27, 2014

(54) SIMULATION SYSTEM FOR SIMULATING I/O PERFORMANCE OF VOLUME AND SIMULATION METHOD

(71) Applicants: Keisuke Fukumoto, Yokohama (JP); Yasufumi Uchiyama, Yokohama (JP); Yoichiro Tsuge, Yokohama (JP)

(72) Inventors: Keisuke Fukumoto, Yokohama (JP); Yasufumi Uchiyama, Yokohama (JP); Yoichiro Tsuge, Yokohama (JP)

(73) Assignee: HITACHI, LTD., Tokyo (JP)

(21) Appl. No.: 13/640,430

(22) PCT Filed: Aug. 24, 2012
(86) PCT No.: PCT/JP2012/071409

§ 371 Date: Nov. 14, 2012

(51) Int. Cl. G06G 7/62

(52) U.S. Cl. 703/21

(57) ABSTRACT

An example is a simulation method for I/O performance of a volume of a first storage apparatus in a simulation target storage apparatus, including: obtaining an I/O history of a period regarding a first migration source volume in the first storage apparatus; obtaining first information indicating at least intra-volume addresses of cache data of the first migration source volume at start of the period; referring to the first information to determine cache data having addresses in a migration destination volume corresponding to at least some of the intra-volume addresses of the cache data of the first migration source volume and determining the determined cache data as cache data of a first simulation target volume of the simulation target storage apparatus; and issuing simulation-use I/O requests to the first simulation target volume according to the I/O history of the period to measure I/O performance of the first simulation target volume.

### BACKGROUND

This invention relates to a simulation system for simulating the I/O performance of a volume and a simulation method.

Business organizations are tackling the migration/consolidation of volumes (storage apparatus) for cost reduction. It is important in migrating/consolidating volumes (storage apparatus) that a migration destination storage apparatus or a consolidated storage apparatus be capable of fulfilling in actual operation a level of performance required at the migration source.

There is a technology for improving the I/O performance of a storage apparatus with respect to an application while reducing the cost of the storage apparatus (see, for example, Patent Document 1), by automatically allocating a page (a part of a volume) that is accessed frequently to a high I/O performance drive and allocating an infrequently accessed page to a low I/O performance drive based on the input/output per second (IOPS) from the application to the page.
Patent Document 1: Japanese Patent Application Laid-open No. 2009-223442

### SUMMARY

The technology of Patent Document 1 is expected to be successful in allocating a page that is high in required performance level (a frequently accessed page) to a high I/O performance drive, but this allocation does not guarantee that the storage apparatus fulfills the required level of performance (response performance) of the application. A technology capable of simulating with high precision the performance of a migration destination storage apparatus or a consolidated storage apparatus in the migration/consolidation of volumes (storage apparatus) is therefore being sought.

An aspect of this invention is a simulation system for simulating I/O performance of a volume of a first storage apparatus in a simulation target storage apparatus. The simulation system includes a memory device and a processor. The memory device holds an I/O history of a predetermined period with respect to a first migration source volume in the first storage apparatus, and first information comprising intra-volume addresses of cache data of the first migration source volume at start of the predetermined period. The processor is configured to refer to the first information to determine cache data having addresses in a migration destination volume that correspond to at least some of the intra-volume addresses of the cache data of the first migration source volume at the start, and determine the determined cache data as cache data of a first simulation target volume of the simulation target storage apparatus, and issue simulation-use I/O requests to the first simulation target volume in accordance with the I/O history of the predetermined period.

According to the aspect of this invention, whether or not the migration destination of a volume fulfills a level of performance required of the migrated volume can be simulated with high precision.

### BRIEF DESCRIPTION OF THE DRAWINGS

FIG. 1 is a diagram schematically illustrating a configuration example of a computer system according to an embodiment of this invention.

FIG. 2 is a diagram schematically illustrating a configuration example of a management server according to the embodiment.

FIG. 3 is a diagram schematically illustrating a configuration example of an application server according to the embodiment.

FIG. 4 is a diagram schematically illustrating a configuration example of a storage apparatus according to the embodiment.

FIG. 5 is a flow chart illustrating an overall flow of a management server program for simulating the performance of a migration destination according to the embodiment.

FIG. 6 is a diagram schematically illustrating an example of an image for I/O information obtainment setting according to the embodiment.

FIG. 7 is a diagram schematically illustrating an example of an image for reproduction I/O and I/O reproduction destination selection according to the embodiment.

FIG. 8 is a diagram schematically illustrating an example of an image for showing an I/O reproduction result according to the embodiment.

FIG. 9 is a flow chart illustrating an example of an information obtainment setting step according to the embodiment.

FIG. 10 is a diagram schematically illustrating a configuration example of a migration source volume registration table according to the embodiment.

FIG. 11 is a diagram schematically illustrating a configuration example of an information obtainment settings management table according to the embodiment.

FIG. 12 is a flow chart illustrating an example of a reproduction information obtainment step according to the embodiment.

FIG. 13 is a diagram schematically illustrating a configuration example of a cache information recording table according to the embodiment.

FIG. 14 is a diagram schematically illustrating a configuration example of an I/O information recording table according to the embodiment.

FIG. 15 is a diagram schematically illustrating a configuration example of an I/O information saved period recording table according to the embodiment.

FIG. 16 is a conceptual diagram illustrating a method of obtaining I/O information (an I/O history) according to the embodiment.

FIG. 17 is a flow chart illustrating an example of a reproduction method setting step according to the embodiment.

FIG. 18 is a diagram schematically illustrating a configuration example of a reproduction execution table according to the embodiment.

FIG. 19 is a flow chart illustrating an example of a reproduction execution step according to the embodiment.

FIG. 20 is a diagram schematically illustrating a configuration example of an I/O response time recording table according to the embodiment.

FIG. 21 is a conceptual diagram illustrating a method of reproducing a cache in a migration destination storage apparatus according to the embodiment.

FIG. 22 is a flow chart illustrating an example of a reproduction result display step according to the embodiment.

### DETAILED DESCRIPTION OF THE EMBODIMENTS

Embodiments of this invention are described below with reference to the accompanying drawings. It should be noted that the embodiments are merely examples of how this invention is carried out, and are not to limit the technical scope of this invention. Duplicate descriptions are omitted if necessary for a clearer description.

A system of this embodiment records a history of input/output (I/O) from an application program (also referred to as application) to a migration source volume and reproduces the recorded I/O history for a simulation target volume. The system measures the response performance of the simulation target volume to the reproduced I/O, and can thus simulate with high precision whether or not the simulation target volume fulfills a requested performance level.

A simulation of this embodiment involves reproducing the cache state of the migration source volume at the beginning of the simulation. This accomplishes a more precise simulation. The simulation is also executed efficiently in short time by limiting the period of the I/O history that is reproduced for the simulation. The cache state and the I/O history that are reproduced in a simulation target storage apparatus are not always exactly the same as the cache state and the I/O history at the reproduction source. For instance, write data in the I/O history and cache data in the cache may have values different from those at the reproduction source. As described later, in the simulation of a plurality of volumes, only a part of the cache state is reproduced for each of migration source volumes.

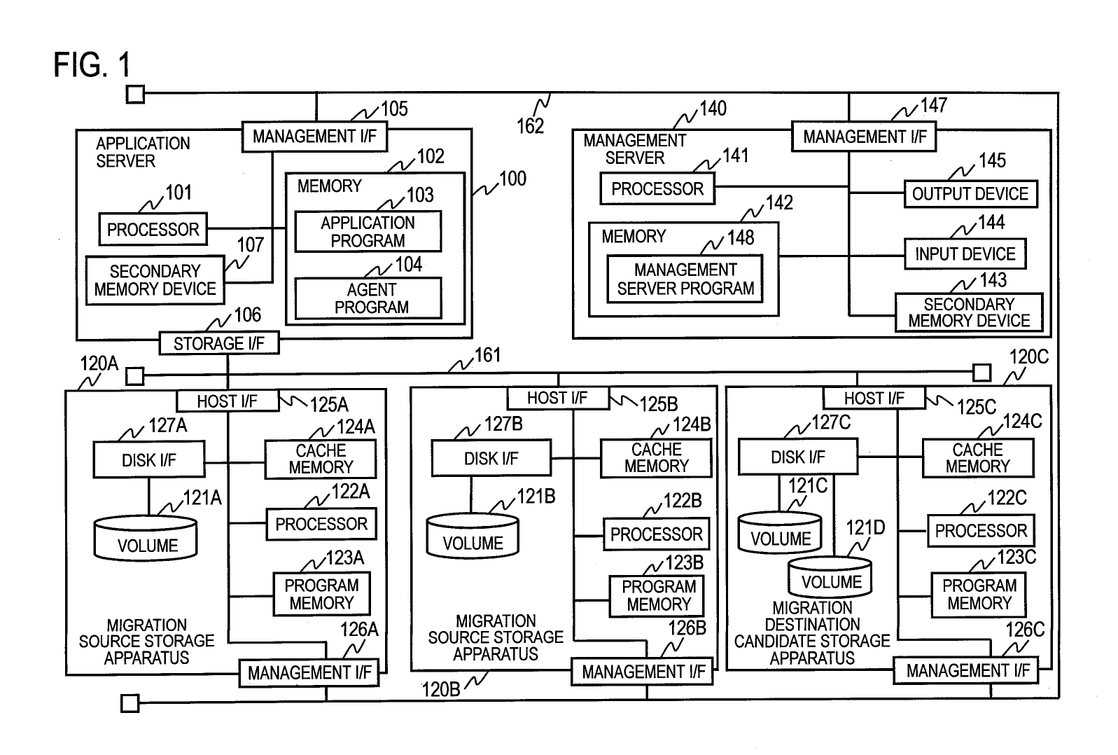

FIG. 1 schematically illustrates a configuration example of a computer system of this embodiment. This computer system includes an application server 100, migration source storage apparatus 120A and 120B and a migration destination candidate storage apparatus 120C which are accessed by the application server 100, and a management server 140 which manages the application server 100 and the storage apparatus 120A to 120C. The number of computers (servers) and the number of storage apparatus in the system depend on design.

The application server 100 and the storage apparatus 120A to 120C are coupled to one another by a data network 161. The data network 161 is a data communication network, for example, a storage area network (SAN). The data network 161 can be other networks than a SAN as long as the data network 161 is a data communication network, for example, an IP network.

The application server 100, the storage apparatus 120A to 120C, and the management server 140 are coupled to one another by a management network 162. The management network 162 is, for example, an IP network. The management network 162 can be other networks than an IP network as long as the management network 162 is a network for communicating management data, for example, a SAN. The data network 161 and the management network 162 may be the same network.

In the configuration example of FIG. 1, the storage apparatus 120A and 120B provide volumes 121A and 121B to an application program 103 of the application server 100. In this example, the performance of I/O (the performance of access) to volumes 121C and 121D in the storage apparatus 120C is simulated. The volumes 121C and 121D correspond to the volumes 121A and 121B, respectively, and have the same capacity as, or a larger capacity than, the capacity of the corresponding volume. Details of how the simulation is executed are described later.

The simulation target storage apparatus 120C, which, in the following description, is actually a migration destination candidate of the volumes 121A and 121B (data in the volumes) accessed by the application program 103, can be a storage apparatus of any configuration for simulating the performance of a migration destination candidate. For instance, the simulation target storage apparatus 120C may be a storage apparatus having the same configuration as that of another migration destination candidate storage apparatus, or may be a storage apparatus used exclusively for the I/O performance simulation.

The storage apparatus 120A includes a processor 122A, a program memory 123A, a cache memory 124A, a host interface (I/F) 125A, a management I/F 126A, and a disk I/F 127A. The storage apparatus 120B includes a processor 122B, a program memory 123B, a cache memory 124B, a host I/F 125B, a management I/F 126B, and a disk I/F 127B.

The storage apparatus 120C includes a processor 122C, a program memory 123C, a cache memory 124C, a host I/F 125C, a management I/F 126C, and a disk I/F 127C. Details of the configuration of the storage apparatus 120A to 120C are described later.

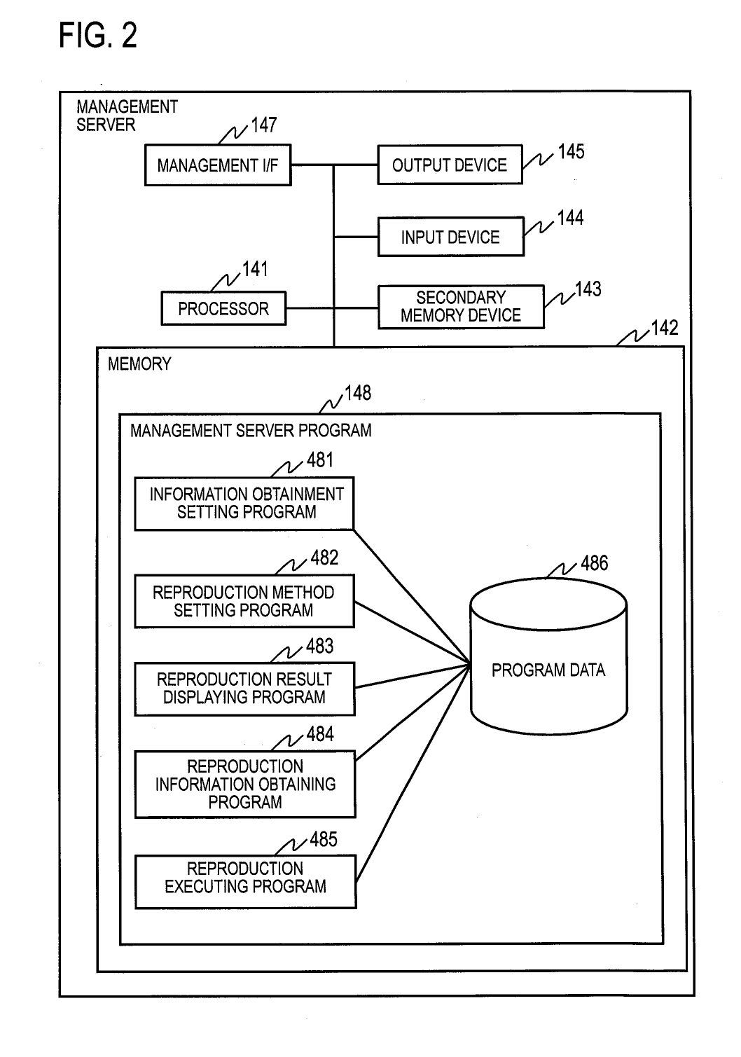

FIG. 2 is a diagram schematically illustrating the configuration of the management server 140. The management server 140 is a management system that manages the application server 100 and the storage apparatus 120A to 120C. The management server 140 in this example is included in the simulation system for simulating the performance of the storage apparatus 120C. The simulation system includes the management server 140 and the application server 100 in an example described below. Alternatively, functions of the application server 100 that are used for the simulation may be possessed by the management server 140.

In the management system and the simulation system which can include at least one computer, one of the plurality of computers may be a display-use computer, and processing procedures equivalent to one another may be performed by two or more out of the plurality of computers in order to enhance the processing speed and reliability.

The management server 140 includes a processor 141, a memory 142 which is a main memory device, a non-volatile secondary memory device 143, an input device 144, an output device 145, and a management I/F 147. Those components are connected to one another via a bus so that the components can communicate to/from one another. The output device 145 is, for example, a liquid crystal display device. The input device 144 is constituted of, for example, a keyboard and a mouse. An administrator obtains necessary information via the output device 145 and inputs necessary information via the input device 144.

The management I/F 147 is a network interface that couples to the management network 162. The management I/F 147 exchanges data and control commands with the storage apparatus 120A to 120C or the application server 100 over the management network 162.

The processor 141 operates as programmed by a program that is stored in the memory 142. A program and data that are stored in the secondary memory device 143 are loaded onto the memory 142. The secondary memory device 143 may be coupled via an external network. The memory 142 in FIG. 2 stores a management server program 148. The management server program 148 executes processing for simulating the performance of the storage apparatus 120C.

The management server program 148 in the example of FIG. 2 includes a plurality of programs, specifically, an information obtainment setting program 481, a reproduction method setting program 482, a reproduction result displaying program 483, a reproduction information obtaining program 484, and a reproduction executing program 485. Those programs use program data 486. Details of processing of those programs and the specifics of the program data 486 are described later.

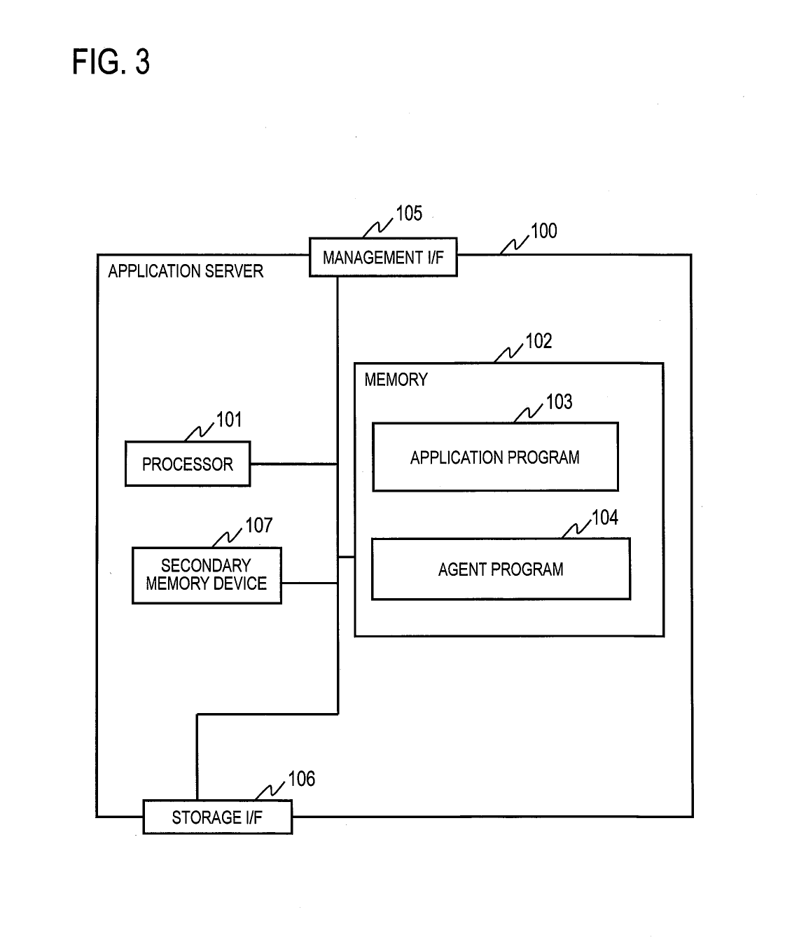

FIG. 3 is a diagram schematically illustrating the configuration of the application server 100. The application server 100 includes a processor 101, a memory 102 which is a main memory device, a management I/F 105, a storage I/F 106, and a non-volatile secondary memory device 107. Those components are connected to one another via a bus so that the components can communicate to/from one another. The processor 101 operates as programmed by a program that is stored in the memory 102. A program and data that are stored in the secondary memory device 107 are loaded onto the memory 102.

The storage I/F 106 is a network interface that couples to the data network 161. The storage I/F 106 exchanges data and control commands (including I/O requests) with the storage apparatus 120A to 120C over the data network 161. I/O requests include read requests and write requests.

The management I/F 105 is a network interface that couples to the management network 162. The management I/F 105 can exchange data and control commands with the storage apparatus 120A to 120C and the management server 140 over the management network 162.

The memory 102 stores the application program 103 and an agent program 104. The application program 103 reads and writes data in the data volumes 121A and 121B to perform a service. The agent program 104 issues an I/O request instructed by the management server 140 to the storage apparatus 120C in order to simulate the performance of the storage apparatus 120C. The agent program 104 may be installed in a computer different from that of the application program 103, for example, the management server 140. The application server 100 has an open system platform or a main frame platform.

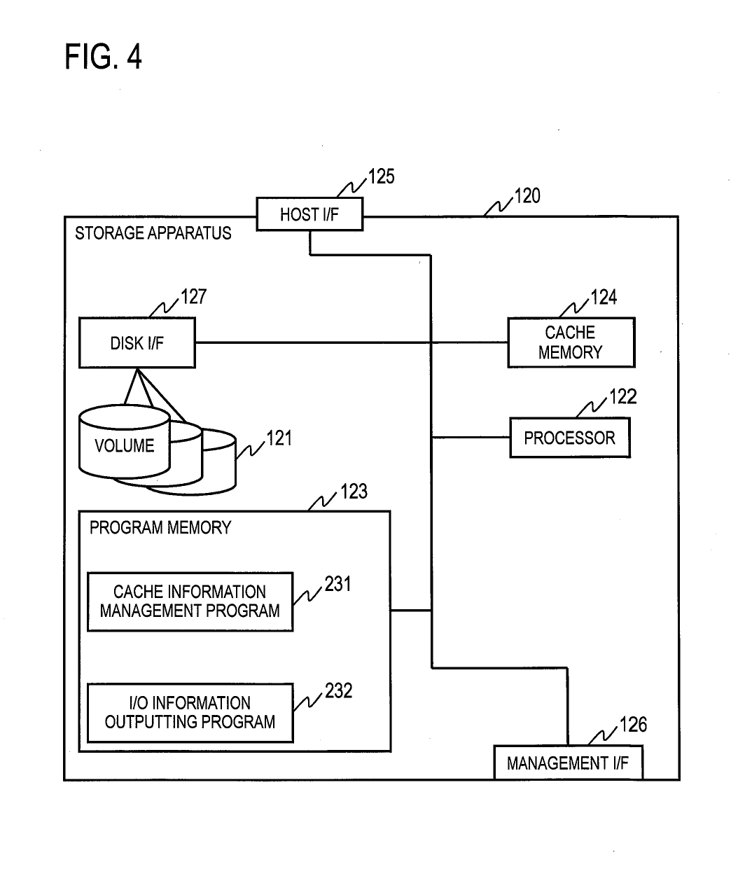

FIG. 4 is a diagram schematically illustrating the configuration of the storage apparatus 120A to 120C. The storage apparatus 120A to 120C in this example each include components illustrated in FIG. 4. In the following description, “storage apparatus 120” refers to any one of the storage apparatus 120A to 120C. The storage apparatus 120 includes a disk drive (for example, hard disk drive or solid-state drive) group and a storage controller. The disk drive group provides one volume 121 or a plurality of volumes 121 to store data requested by the application server 100 to be written. The storage controller controls processing of the storage apparatus 120.

The storage controller includes a processor 122, a program memory 123 which is a memory device, a cache memory 124, a host I/F 125, a management I/F 126, and a disk I/F 127. The host I/F 125 is a network interface that couples the storage controller to the data network 161. The host I/F 125 exchanges data and control commands (including I/O requests) with the application server 100 over the data network 161.

The management I/F 126 is a network interface that couples the storage controller to the management network 162. The management I/F 126 exchanges data and control commands with the management server 140 and the application server 100 over the management network 162. The disk I/F 127 is an interface that connects the storage controller to the disk drive group.

The processor 122 executes a program stored in the program memory 123. The program memory 123 in FIG. 4 stores a cache information management program 231 and an I/O information outputting program 232. Processing of those programs is described later. FIG. 4 illustrates only programs relevant to the simulation according to this embodiment, but the program memory 123 stores programs necessary for usual functions of the storage apparatus 120 such as host I/O processing, cache control, and copy control, and the processor 122 implements the necessary functions as programmed by those programs.

A program is executed by a processor, to thereby perform given processing with the use of a memory device and an interface. Accordingly, a description of this embodiment that has “program” as the subject can be read as a description with “processor” as the subject. In other words, processing executed by a program is processing performed by an apparatus and a system where the program is run.

A processor operates as programmed by a program, to thereby act as a function module that implements a given function. The processor also acts as function modules that carry out a plurality of types of processing executed by respective programs. An apparatus and a system that include the processor are an apparatus and a system that include those function modules. How many chips constitute a processor is not limited.

In the embodiment, the information used by a system (an apparatus) does not depend on the data structure, and information used by the system can be expressed in any data structure. For example, an appropriate data structure selected from the table format, the list format, the database format, and the queue format can store information. Information used by the system is stored in a storage area in a memory device. For each type of information, the specifics of the information are described with the use of an expression “identification information”, “identifier”, “name”, “ID”, “number”, or the like. Those can be substituted by one another unless specifically noted otherwise.

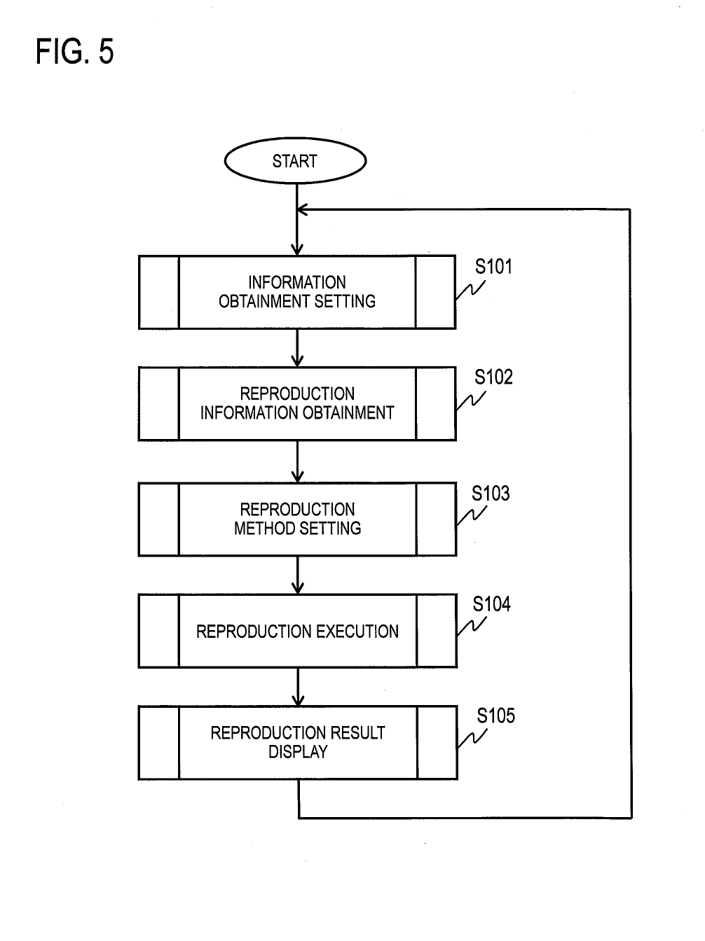

A method of simulating the I/O performance of a volume migrated to the storage apparatus 120C is described below. FIG. 5 is a flow chart illustrating the overall flow of processing that is executed by the management server program 148 to simulate the performance of the storage apparatus 120C according to this embodiment.

The flow chart of FIG. 5 has an information obtainment setting step S101, where an administrator (a user) sets settings about the obtainment of I/O history (information) for the simulation. In this example, a history of I/O requests from the application server 100 to the migration source volumes 121A and 121B is recorded, and a series of I/O requests determined based on the history is issued to the simulation target storage apparatus 120C. Conditions for obtaining an I/O history (information) that can be used for the simulation are defined in Step S101.

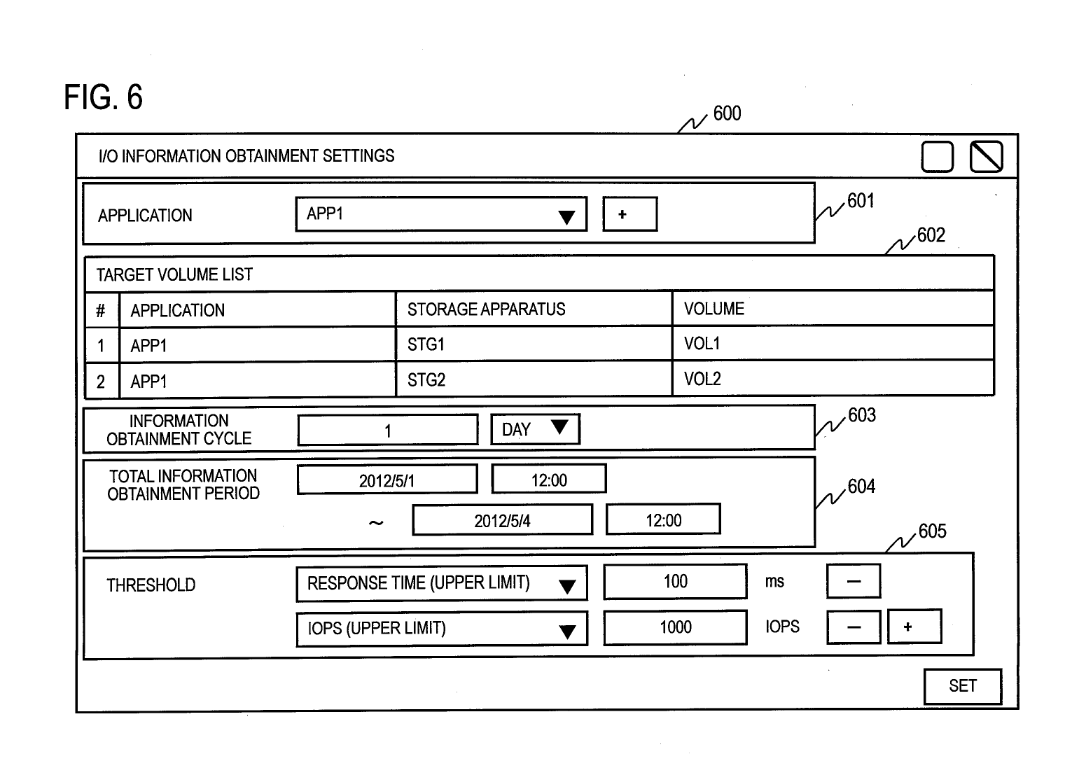

FIG. 6 illustrates an example of a GUI image 600 for the information obtainment setting (S101). The output device 145 of the management server 140 presents the image 600 of FIG. 6 to the user. The administrator uses the input device 144 to input (set) necessary information in the GUI image 600. Downward triangles in FIG. 6 represent pull-down menus, which applies to other GUI images.

The administrator selects in the information obtainment setting image 600 a volume of an application that is to be simulated for migration. An application section 601 in FIG. 6 displays an application for which an I/O history is obtained. The administrator can select one application or a plurality of applications in the application section 601.

In the example of FIG. 6, an application APP1 (the application program 103) is selected. The administrator can increase or decrease the number of applications to be selected by selecting a “+” button or a “−” button (not shown) in the application section 601.

A target volume list section 602 displays a list of volumes used by the selected application. The section 602 in the example of FIG. 6 displays volumes VOL1 (121A) and VOL2 (121B) of storage apparatus STG1 (120A) and STG2 (120B). In the case where a plurality of applications are selected, volumes of all the selected applications are displayed.

In this example, all volumes provided to a selected application are counted as target volumes for which an I/O history is obtained. The image 600 may be modified so that the administrator can further select a target volume for which an I/O history is obtained from among all volumes of a selected application. The management server program 148 may allow the administrator to select a volume without selecting an application.

The administrator uses the input device 144 to further set respective values in an information obtainment cycle section 603, a total information obtainment period section 604, and a threshold section 605 in the information obtainment setting image 600. The set values may differ from one application to another or may be common to all applications. The sections may also allow the administrator to set values different from one volume to another.

The information obtainment cycle section 603 is for defining a cycle in which an I/O history (information) is obtained. A one-day cycle is set in the example of FIG. 6. The administrator can set a cycle of an arbitrary length in hours, days, months, or other units. The total information obtainment period section 604 is for defining a total period (constituted of one cycle or a plurality of cycles) for which an I/O history is obtained.

A total information obtainment period of three days, “2012/5/1/12:00˜2012/5/4/12:00”, is set in the example of FIG. 6. The administrator can set a total obtainment period of an arbitrary length and a cycle of an arbitrary length in hours, days, months, or other units. According to the settings in the example of FIG. 6, three cycles of I/O history in the specified total obtainment period are obtained for each selected volume.

The threshold section 605 is for defining an I/O performance condition (I/O load condition) that is to be satisfied by an I/O history of each cycle (each obtainment period) used in the simulation. An upper limit of response time and an upper limit of input/output per second (IOPS) are set in the example of FIG. 6. A response time is, for example, the length of time from the reception of a request at the storage apparatus 120A or 120B to the return of a notification of the request's completion to the requestor. IOPS is, for example, the sum of write requests and read requests issued to one volume within a unit time.

To give an example, an I/O history within a cycle that satisfies one of condition items can be used for the simulation. Alternatively, only an I/O history in a cycle that satisfies all condition items defined may be used for the simulation.

In the example of FIG. 6, the upper limit of response time is 100 ms and the upper limit of IOPS is 1,000. When one of entries of an I/O history within a cycle satisfies at least one of the two condition items described above, specifically, when one of I/O response time records within a cycle is 100 ms or more, or when the IOPS at one point within a cycle is 1,000 or more, an I/O history within the cycle constitutes a candidate history to be used in the simulation of the storage apparatus 120C. An I/O history that has a value smaller than a threshold may be employed for the simulation.

While an upper limit of response time and an upper limit of IOPS are defined as thresholds for an I/O history to be used in the example of FIG. 6, other condition items can be used in this system. For instance, the system can use an average response time within a cycle and an average IOPS within a cycle. The system may also use the CPU utilization ratio, disk I/F utilization ratio, or the like of a storage apparatus. The administrator can increase or decrease the threshold items (condition items) by selecting a “+” button or a “−” button in the threshold section 605.

By obtaining only an I/O history within a period that satisfies a specific I/O performance condition (I/O load condition) in this manner, an I/O history appropriate for the simulation is obtained efficiently. Further, allowing the user to specify obtainment conditions makes it possible to properly perform a simulation that the user requests. While a cycle within a total obtainment period is defined in the example described above, the image 600 may be designed so that a start date/time and an end date/time are set for each of a plurality of obtainment periods.

Returning to FIG. 5, the next step is a reproduction information obtainment step S102. The reproduction information obtainment step S102 is for obtaining information in the storage apparatus 120A to 120B that is used for the simulation of the I/O performance of the volumes 121C and 121D in the storage apparatus 120C (information to be reproduced). The obtained information is information about an I/O history and cache data. Details of Step S102 are described later.

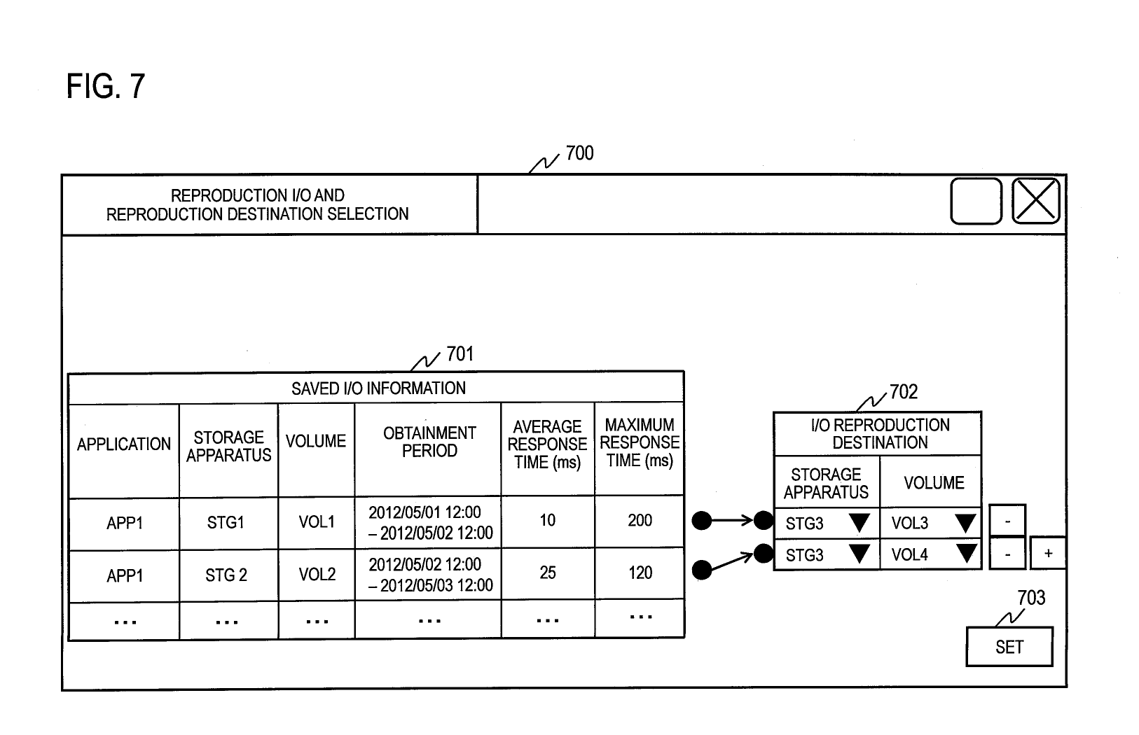

The next step is a reproduction method setting step S103. Step S103 is for setting which I/O is to be reproduced for the simulation of the storage apparatus 120C. The administrator can specify an I/O reproduction method for a simulation in Step S103. FIG. 7 illustrates an example of a GUI image 700 which allows the administrator to select reproduction I/O and a reproduction destination. The output device 145 of the management server 140 presents the GUI image 700 to the administrator. The administrator uses the input device 144 to input (set) necessary information in the reproduction I/O and reproduction destination selection image 700.

The reproduction I/O and reproduction destination selection image 700 includes a saved I/O information section 701 and an I/O reproduction destination section 702. The saved I/O information section 701 displays a list of I/O histories within a cycle obtained and saved (an obtainment period) in the storage apparatus 120A and 120B. An I/O history in a cycle that satisfies an I/O performance condition (I/O load condition) defined in the information obtainment setting step S101 is obtained as described above, and the saved I/O information section 701 displays information of the I/O history within the cycle that satisfies the defined condition. In the example of FIG. 7, all entries that satisfy the condition are displayed.

Each entry in the saved I/O information section 701 includes a field for storing the identifier of an application, a field for storing the identifier of a storage apparatus, a field for storing the identifier of a volume, a field for storing a numerical value that indicates an obtainment period, a field for storing a value that indicates an average response time in the obtainment period, and a field that indicates a maximum response time in the obtainment period. The saved I/O information section 701 may display different types of information from the ones in this example. For instance, the saved I/O information section 701 may display information about IOPS or may not display information about response time.

The administrator selects from the saved I/O information section 701 an I/O history (entry) to be used for the simulation of a storage apparatus STG3 (120C). The administrator selects only one entry for one volume. In the example of FIG. 7, an entry is selected for each of the two volumes VOL1 (121A) and VOL2 (121B). Those entries have different I/O history obtainment periods. As described later, the simulation of the storage apparatus STG3 (120C) includes issuing, in the same period, I/O requests of different obtainment periods.

The administrator can thus select I/O histories of different obtainment periods. This performs the simulation under strict conditions possible. The management server 140 may also be configured so that only entries of the same obtainment period can be selected.

The I/O reproduction destination section 702 is provided to specify a storage apparatus and a volume for which the simulation is performed (a storage apparatus and a volume where the I/O of a migration source volume is reproduced for the simulation). The administrator selects from a list displayed in the I/O reproduction destination section 702 a storage apparatus and a volume for which the simulation is performed (a simulation target storage apparatus and a simulation target volume). The administrator further associates the simulation target volume with the migration source volume.

In this example, the storage apparatus STG3 (120C) is selected as a reproduction destination storage apparatus (simulation target storage apparatus). Volumes VOL3 (121C) and VOL4 (121D) of STG3 are selected as reproduction destination volumes (simulation target volumes) and are associated with the volumes VOL1 (121A) and VOL2 (121B), respectively.

The capacity of a reproduction destination volume (for example, the volume VOL3) is equal to or larger than that of its associated reproduction source volume (for example, the volume VOL1). The reproduction destination volume may store or may not store the same data that is stored in the reproduction source volume (data at the start of an obtainment period). A reproduction destination volume thus does not need to be exactly the same as its associated reproduction source volume. Selecting a “set” button 703 enters input settings.

Referring back to FIG. 5, the next step is a reproduction execution step S104. In Step S104, a cache state associated with a selected I/O history and the selected I/O history are simulated in the reproduction destination storage apparatus 120C to simulate the performance of the storage apparatus 120C. Details thereof are described later.

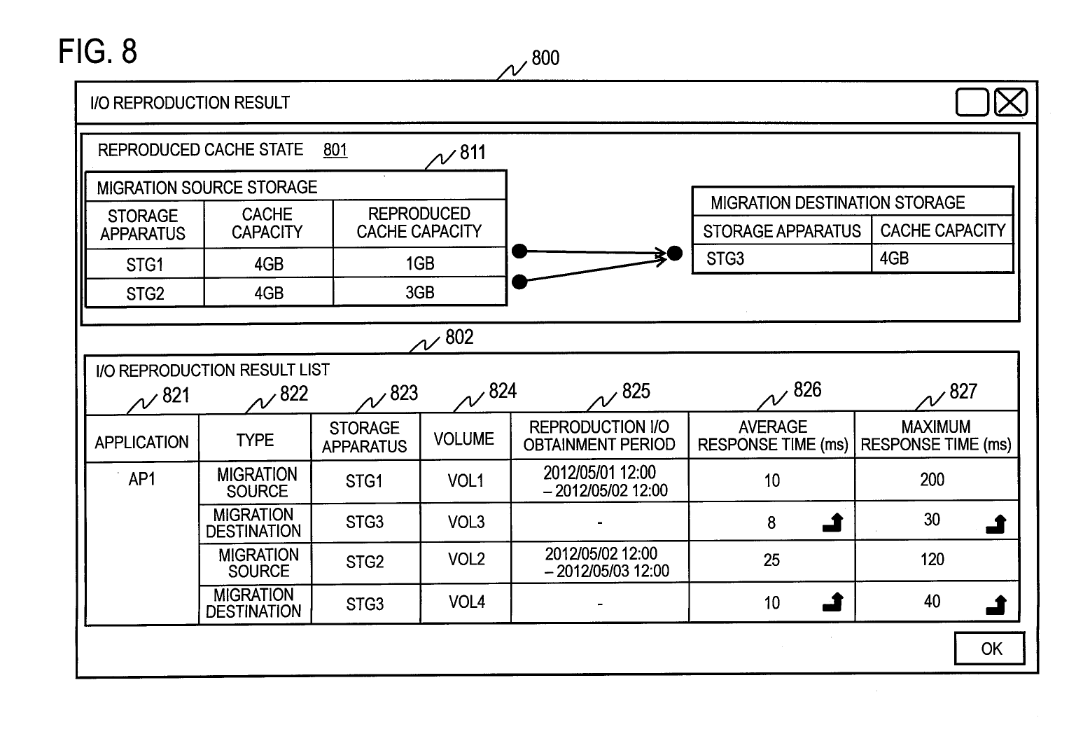

The next step is a reproduction result display step S105. Step S105 is for displaying a result of simulating the storage apparatus 120C. The administrator checks the simulation result and obtains necessary information in this manner. FIG. 8 illustrates an example of an I/O reproduction result image 800 for displaying a simulation result. The I/O reproduction result image 800 includes a reproduced cache state section 801 and an I/O reproduction result list section 802. The reproduced cache state section 801 displays a cache capacity allocated to an application (a volume) in a simulation (a reproduced cache capacity). In this example, as described later, cache data is prepared in advance in a cache memory 124C at the start of the simulation of the storage apparatus STG3 (120C). Cache data of a simulation target volume at the start of the simulation is determined in this example by cache data of its associated migration source volume at the start of an I/O history obtainment period. This accomplishes an even more precise simulation.

The reproduced cache state section 801 displays a cache capacity allocated to the application APP1 (VOL1 and VOL2) in the migration source storage apparatus STG1 (120A) and STG2 (120B), and a cache capacity allocated to (reproduced in) the migration destination (simulation target) storage apparatus STG3 (120C).

The storage apparatus STG1 (120A) to STG3 (120C) in this example have a function of dividing a resource that contains a cache memory (cache capacity) into a plurality of resource groups. The resource groups are allocated exclusively to tenants, applications, volumes, or the like. In the example of FIG. 8, each of the storage apparatus STG1 (120A) to STG3 (120C) allocates a cache space of 4 GB out of the total cache capacity of the storage apparatus to APP1 alone.

The storage apparatus STG3 (120C) in the example of FIG. 8 allocates a cache space (cache capacity) of 4 GB to the application APP1 (VOL3 and VOL4). Only the application APP1 (VOL3 and VOL4) is allowed to use the 4-GB cache space during the simulation.

The storage apparatus STG1 (120A) allocates a cache space (cache capacity) of 4 GB to the application APP1 (VOL1), and the storage apparatus STG2 (120B) allocates a cache space (cache capacity) of 4 GB to the application APP1 (VOL2).

The cache capacity allocated in the storage apparatus STG3 (120C) is smaller than the total cache capacity allocated in the migration source storage apparatus STG1 (120A) and STG2 (120B). Accordingly, not all pieces of information in the cache memories (cache state) of the storage apparatus STG1 (120A) and STG2 (120B) at the start of an I/O history obtainment period can be reflected on the cache memory of the storage apparatus STG3 (120C) at the start of the simulation.

Only the state of a part of cache spaces that are allocated in the migration source storage apparatus STG1 (120A) and STG2 (120B) to the application APP1 (VOL1 and VOL2) (partial cache data) is therefore reproduced in the storage apparatus STG3 (120C) at the start of the simulation.

In the example of FIG. 8, 1 GB of cache data of the storage apparatus STG1 (120A) and 3 GB of cache data of the storage apparatus STG2 (120B) are stored in the cache memory of the storage apparatus STG3 (120G) at the start of the simulation.

The amount of cache data held in the migration source storage apparatus STG1 (120A) for the application APP1 (VOL1) and the amount of cache data held in the migration source storage apparatus STG2 (120B) for the application APP1 (VOL2) are respectively equal to or smaller than the capacity allocated in STG1 and the capacity allocated in STG2 which are given above. Cache data at each address in a cache state that is reproduced in the storage apparatus STG3 (120C) at the start of the simulation may or may not be the same as cache data in the migration source storage apparatus STG1 (120A) and STG2 (120B). In other words, it is sufficient if a cache data address (an address simultaneously indicates the data length as well) in one cache matches a cache data address in the other cache.

The management server 140 automatically determines a cache capacity to be allocated to the application APP1 (VOL3 and VOL4) in the simulation (“reproduced cache capacity” in FIG. 8). Details of how the capacity is determined are described later.

In the case where the storage apparatus 120A to 120C do not have the resource dividing function, the same cache memory is used by a plurality of applications. In this configuration, “cache capacity” of, for example, the storage apparatus STG 1 and STG2 in a migration source storage section 811 is a cache memory capacity that is occupied by cache data of the selected application (volume). This corresponds to the amount of cache data of each volume at the start of the selected I/O history obtainment cycle.

“Reproduced cache capacity” in the migration source storage section 811 is, for example, the amount of cache data among cache data of the selected volume that is reflected on the cache space of the simulation target storage apparatus STG3 (120C) at the start of the simulation.

An I/O reproduction result list section 802 in FIG. 8 presents information on an I/O history of a migration source volume used in the simulation and a result of the simulation in a migration destination volume. Specifically, the I/O reproduction result list section 802 includes a column 821 for storing the identifier of a simulation target application, a column 822 which indicates the type (migration source/migration destination) of a volume in the simulation, a column 823 for storing the identifier of a storage apparatus to which the volume belongs, and a column 824 for storing the identifier of the volume.

The I/O reproduction result list section 802 further includes a column 825 which indicates an I/O history obtainment period of the migration source volume used in the simulation, a column 826 which indicates an average response time in the I/O history obtainment period of the migration source volume or an average response time in the result of the of the migration destination volume, and a column 827 which indicates a maximum response time in the I/O history obtainment period of the migration source volume or a maximum response time in the result of the simulation of the migration destination volume. Arrows in the average response time column 826 and the maximum response time column 827 indicate improved performance when pointing upward, and indicate deteriorated performance when pointing downward.

The administrator can check migrated volume information on which the simulation has been performed by referring to the entry of the migration source volume, and can know a simulation result by referring to the entry of the migration destination volume. The images illustrated in FIGS. 6 to 8 are given as an example, and the management server 140 may display only some of information shown by those images, or may display information different from the information shown by those images.

Details of each step in the flow chart of FIG. 5 are described below. The premise of the following description is that only an upper limit of response time is specified as a threshold of an I/O performance condition for defining which I/O history is used (saved).

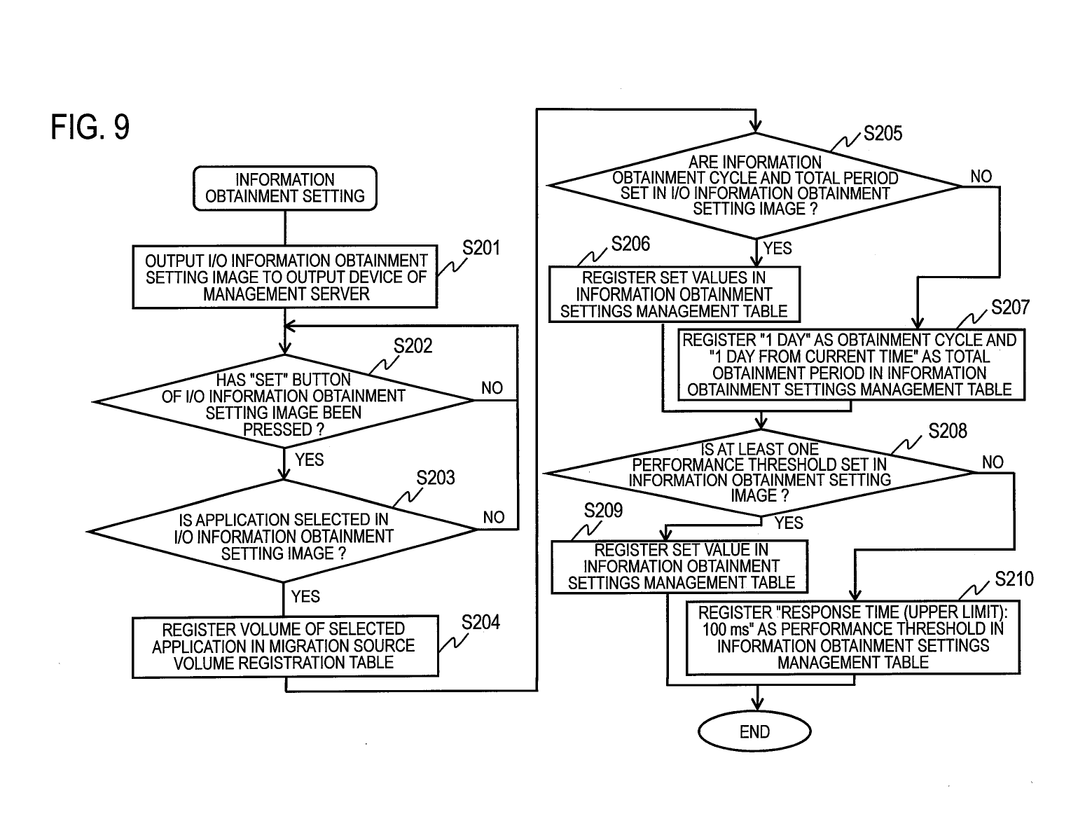

FIG. 9 is a flow chart illustrating an example of the information obtainment setting step S101. The information obtainment setting program 481 executes this flow. The information obtainment setting program 481 first outputs the I/O information obtainment setting image 600 (FIG. 6) to the output device 145 of the management server 140 (S201).

The information obtainment setting program 481 determines whether or not a “set” button of the I/O information obtainment setting image 600 has been pressed (S202). In the case where the “set” button has not been pressed (S202: NO), the information obtainment setting program 481 repeats Step S202. In the case where the “set” button has been pressed (S202: YES), the information obtainment setting program 481 determines whether or not an application is selected in the application section 601 of the I/O information obtainment setting image 600 (S203).

In the case where no application is selected (S203: NO), the information obtainment setting program 481 returns to Step S202. In the case where an application is selected (S203: YES), the information obtainment setting program 481 registers a volume of the selected application in a migration source volume registration table 910.

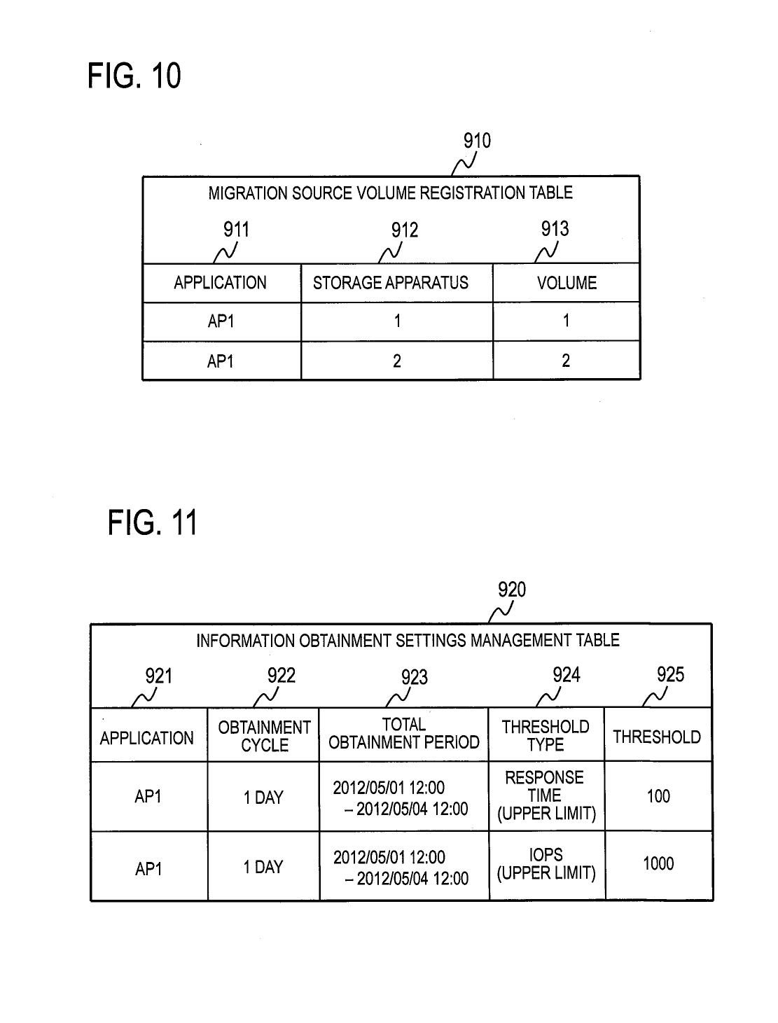

FIG. 10 is a diagram illustrating a configuration example of the migration source volume registration table 910. The migration source volume registration table 910 is included in the program data 486 of the management server program 148. The migration source volume registration table 910 includes an application column 911, a storage apparatus column 912, and a volume column 913.

The application column 911 stores the identifier of a selected application. The storage apparatus column 912 stores the identifier of a storage apparatus that provides a volume used by the application. The volume column 913 stores the identifier of the volume used by the application. Information on which volume is used by which application is registered in the management server 140 in advance. The management server 140 can obtain this information from the input device 144 (administrator) or from the storage apparatus 120A and 120B.

Returning to FIG. 9, the information obtainment setting program 481 determines whether or not values are set in the information obtainment cycle section 603 and the total information obtainment period section 604 of the I/O information obtainment setting image 600 (S205). When the result of the determination is positive (S205: YES), the information obtainment setting program 481 registers the set values in an information obtainment settings management table 920 (S206).

When the result of the determination is negative in Step S205 (S205: NO), the information obtainment setting program 481 registers default values in the information obtainment settings management table 920. In this example, “1 day” is registered as the information obtainment cycle and “1 day from current time” is registered as the total information obtainment period in the information obtainment settings management table 920 (S207).

The information obtainment setting program 481 further determines whether or not at least one threshold is set in the threshold section 605 of the I/O information obtainment setting image 600 (S208). When the result of the determination is positive (S208: YES), the information obtainment setting program 481 registers the set values in the information obtainment settings management table 920 (S209).

When the result of the determination is negative in Step S208 (S208: NO), the information obtainment setting program 481 registers a default value of a default type in the information obtainment settings management table 920 (S210). In this example, that the performance threshold type is “response time (upper limit)” and that the threshold is “100 ms” are registered in the information obtainment settings management table 920.

FIG. 11 illustrates a configuration example of the information obtainment settings management table 920. As described above, the information obtainment settings management table 920 stores information indicating a condition for an I/O history to be used in a simulation. The information obtainment settings management table 920 in this example includes an application column 921, an obtainment cycle column 922, an obtainment period column 923, a threshold type column 924, and a threshold column 925. One entry represents one condition item (threshold) to be satisfied by an I/O history that is used in the simulation.

The application column 921 stores the identifier of a selected application. The obtainment cycle column 922 stores an information obtainment cycle value set in the I/O information obtainment setting image 600, or a default value. The obtainment period column 923 stores a total information obtainment period value set in the I/O information obtainment setting image 600, or a default value. The threshold type column 924 and the threshold column 925 each store a value set in the I/O information obtainment setting image 600 or a default value.

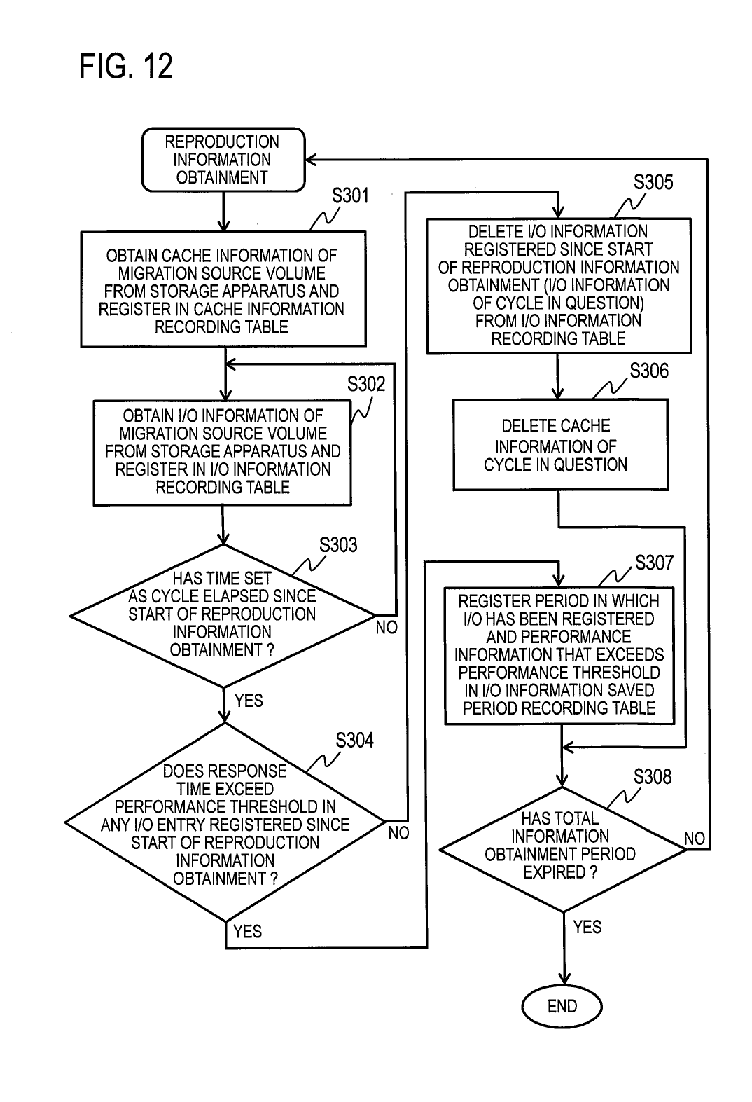

The reproduction information obtainment step S102 is described next with reference to FIG. 12. FIG. 12 is a flow chart illustrating an example of the reproduction information obtainment step S102. The reproduction information obtaining program 484 executes this flow for each specified migration source volume.

The reproduction information obtaining program 484 first obtains from the storage apparatus STG 1 (120A) or STG2 (120B) information about cache data of the migration source volume VOL1 (121A) or VOL2 (121B) at the start of an I/O history obtainment period, and registers the information in a cache information recording table 930 (S301). For instance, at the start of an I/O history obtainment period, the reproduction information obtaining program 484 issues cache information requests with volumes specified to the storage apparatus STG1 (120A) and STG2 (120B) over the management network 162.

In each of the storage apparatus STG1 (120A) and STG2 (120B), the cache information management program 231 refers to the cache memory 124A or 124B to transmit to the management server 140 over the management network 162 cache data of the specified volume and addresses in the volume, along with a level of priority, in response to the received request.

The cache information management program 231 in STG1 may hold a history of the cache memory 124A while the cache information management program 231 in STG2 holds a history of the cache memory 124B so that the contents of the cache space at a specified point in time are transmitted along with a level of priority when requested by the management server 140.

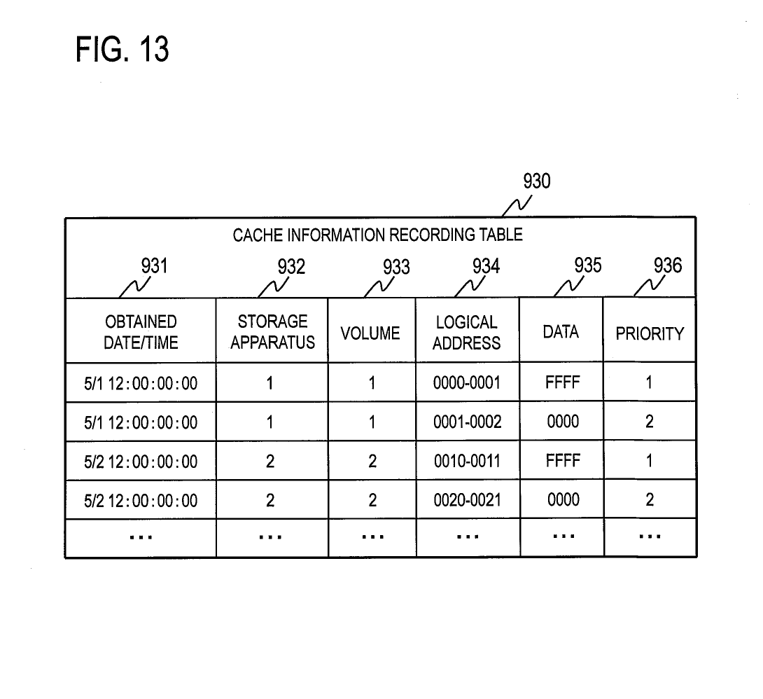

FIG. 13 illustrates a configuration example of the cache information recording table 930. The cache information recording table 930 includes an obtained date/time column 931, a storage apparatus column 932, a volume column 933, a logical address column 934, a data column 935, and a priority column 936.

Each entry represents cache data in one continuous space. The obtained date/column 931 stores a value indicating a date/time at which the reproduction information obtaining program 484 has obtained cache information. The value of each field in the column 931 indicates the start date/time of an I/O history obtainment period. The storage apparatus column 932 in an entry for a piece of cache data stores the identifier of a storage apparatus to which the piece of cache data belongs. The volume column 933 in an entry for a piece of cache data stores the identifier of a volume to which the piece of data belongs. In this example, each storage apparatus and each volume have an identifier unique throughout the system. Volumes of a storage apparatus may have identifiers that are unique just throughout the storage apparatus.

The logical address column 934 in an entry for a piece of cache data stores logical addresses in a volume where the piece of cache data is stored (intra-volume addresses). The column 934 in this example shows cache data addresses (including information about the data length) in the form of a combination of a start logical address and an end logical address. The data column 935 stores cache data. The table 930 may not store cache data.

The priority column 936 stores a value indicating the level of priority of cache data in retaining the cache data in a cache space. Cache data is updated in ascending order of priority. In the example of FIG. 13, an entry where the value of the priority column 936 is smaller has a higher level of priority. In other words, cache data that has a larger priority column value (a lower priority level) is updated (discarded) first.

Priority is determined by a cache algorithm in the storage apparatus. For example, in the case where the Least Recently Used (LRU) algorithm is used, the cache information management program 231 determines a priority value for each entry from the access time of cache data of the entry.

Returning to FIG. 12, the reproduction information obtaining program 484 regularly obtains I/O information (an I/O history) of the migration source volume VOL1 (121A) or VOL2 (121B) from the storage apparatus STG1 (120A) or STG2 (120B) over the management network 162, and registers the information in an I/O information recording table 940 (S302). The I/O information outputting program 232 in the storage apparatus 120A and the I/O information outputting program 232 in the storage apparatus 120B each save an I/O history in the storage apparatus where the I/O information outputting program 232 is being executed, to transmit I/O information (an I/O history) of a specified volume to the management server 140 in response to a request made by the management server 140. The same information may be obtained from the agent program 104 of the application server 100.

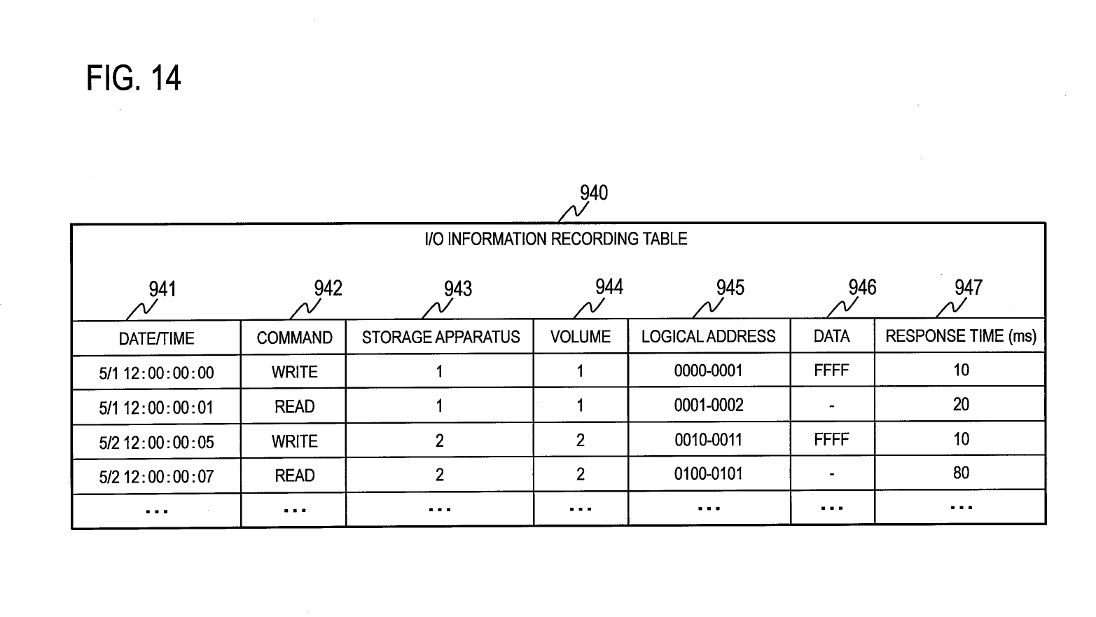

FIG. 14 illustrates a configuration example of the I/O information recording table 940. The I/O information recording table 940 includes a date/time column 941, a command column 942, a storage apparatus column 943, a volume column 944, a logical address column 945, a data column 946, and a response time column 947. Each entry represents an I/O request from the application server 100.

The date/time column 941 indicates a date/time at which the storage apparatus 120 has received an I/O request. The command column 942 indicates the command type (read or write) of the I/O request. The storage apparatus column 943 indicates the identifier of the storage apparatus that has received the I/O request. The volume column 944 indicates the identifier of an access destination volume of the I/O request.

The logical address column 945 indicates access destination logical addresses (intra-volume addresses) of the I/O request. Access destination addresses are shown in the form of a combination of a start logical address and an end logical address. The data column 946 indicates write data in the case where the I/O request is a write request. The response time column 947 indicates a response time taken to respond to the I/O request. Write data may not be obtained and registered.

The I/O information outputting program 232 is capable of analyzing a command that the storage apparatus 120 receives to obtain the date/time of reception, command type, access destination volume, access destination logical addresses, write data, and response time of the command.

Referring back to FIG. 12, the reproduction information obtaining program 484 determines whether or not a length of time set as the information obtainment cycle has elapsed since the start of reproduction information (an I/O history) obtainment (S303). In the case where the result of the determination is negative (S303: NO), the reproduction information obtaining program 484 returns to Step S302.

In the case where the result of the determination is positive (S303: YES), the reproduction information obtaining program 484 determines whether or not the response time (the maximum response time in the cycle) exceeds a preset threshold (100 ms in this example) in any I/O entry registered in the I/O information recording table 940 since the start of reproduction information obtainment (S304).

In the case where the result of the determination is negative (S304: NO), the reproduction information obtaining program 484 deletes from the I/O information recording table 940 pieces of I/O information registered since the start of reproduction information obtainment (entries obtained in the cycle in question) (S305). The reproduction information obtaining program 484 further deletes cache information at the start of the cycle in question from the cache information recording table 930 (S306). The occupation of resources by unnecessary data can thus be avoided.

In the case where the result of the determination is positive (S304: YES), the reproduction information obtaining program 484 registers in an I/O information saved period recording table 950 a period in which I/O information has been recorded within the cycle in question and performance information that exceeds the performance threshold (S307).

Thereafter, the reproduction information obtaining program 484 determines whether or not a set total information obtainment period has expired (S308). The reproduction information obtaining program 484 ends Step S308 in the case where the total information obtainment period has expired (S308: YES), and returns to Step S301 in the case where the total information obtainment period has not expired (S308: NO).

In the case where none of obtainment periods satisfies the I/O performance condition (threshold condition), the reproduction information obtaining program 484 saves I/O information of, for example, the last cycle. The reproduction information obtaining program 484 in the above-mentioned example saves I/O information of every obtainment period in the total information obtainment period that satisfies the I/O performance condition. The reproduction information obtaining program 484 may instead save for each specified volume only I/O information of a first cycle that satisfies the performance threshold condition.

In short, I/O information saved for each specified volume is I/O information of only one cycle. The reproduction information obtaining program 484 in this example omits Step S308 from the flow of FIG. 12 and returns to Step S301 after Step S306.

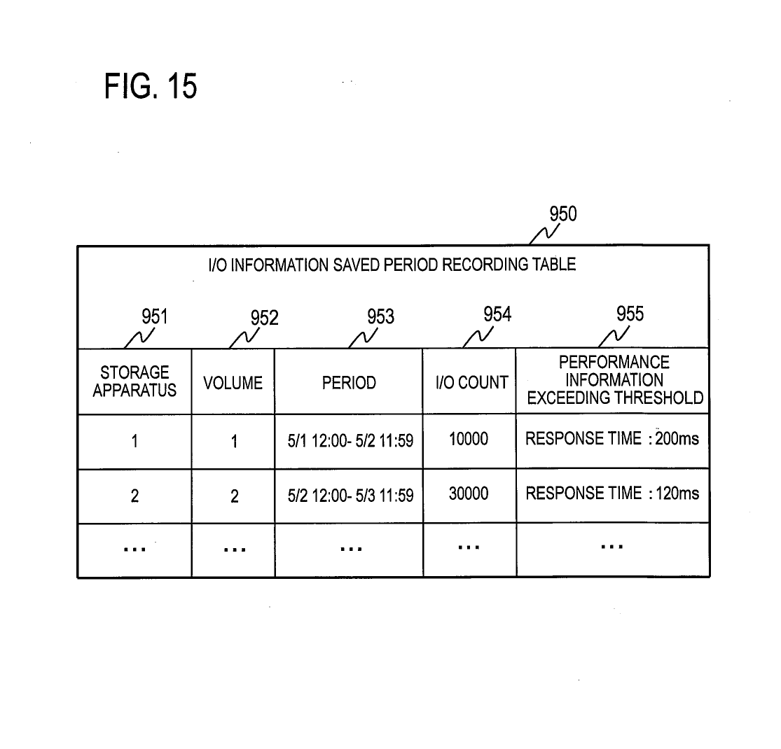

FIG. 15 illustrates a configuration example of the I/O information saved period recording table 950. The I/O information saved period recording table 950 stores information about an I/O history that can be used in a simulation. The I/O information saved period recording table 950 includes a storage apparatus column 951, a volume column 952, a period column 953, an I/O count column 954, and a column 955 for performance information that exceeds a threshold. Each entry represents one obtainment period of a saved I/O history. Specifically, each entry represents an I/O history with respect to one volume in one cycle (saved period) that can be used in the simulation.

The storage apparatus column 951 and the volume column 952 in each entry indicate, respectively, the identifier of an access destination storage apparatus and the identifier of an access destination volume of an I/O request of an I/O history of the entry. The period column 953 indicates a period (cycle) in which the I/O history has been obtained. The I/O count column 954 stores a value indicating the total count of I/O in this period. The column 955 for performance information that exceeds a threshold stores the value of a response time in this period that exceeds a preset threshold. For instance, the value of the maximum response time is stored.

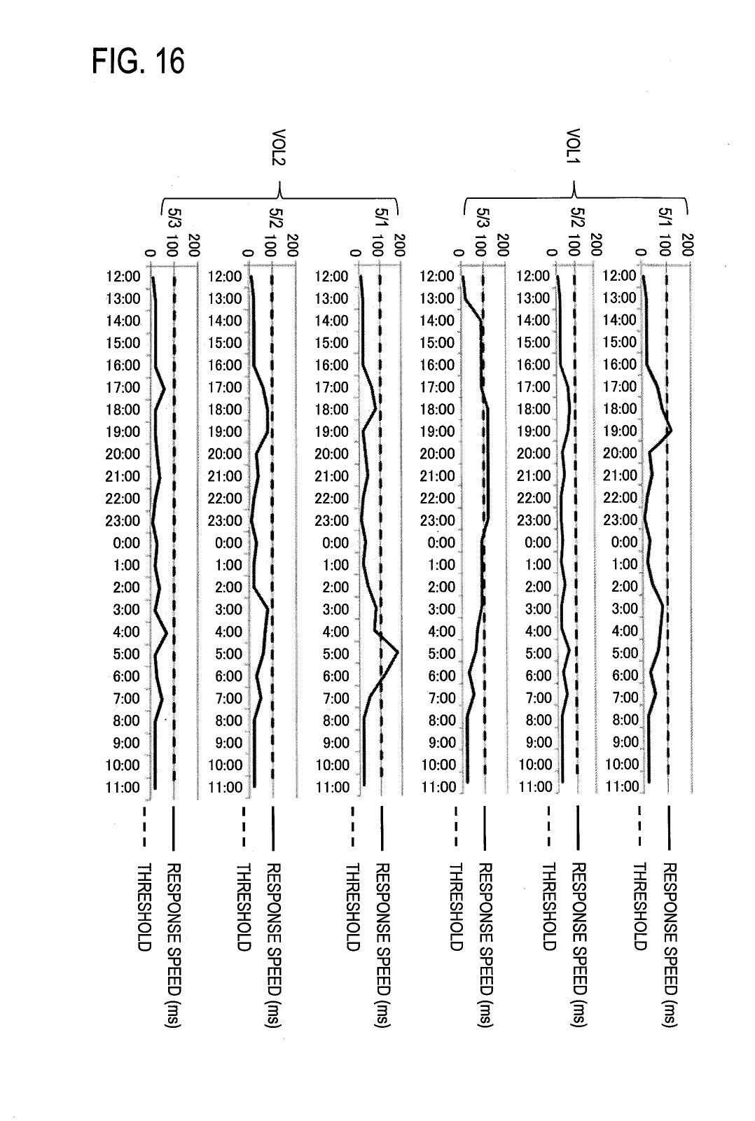

FIG. 16 is a conceptual diagram illustrating how I/O information is saved. The graph of FIG. 16 shows I/O response performance in one-day cycle histories of I/O to VOL1 and VOL2 in a period “5/1:12:00˜5/4:12:00”. The response speed in the I/O history of VOL1 exceeds a threshold on 5/1 and 5/3. I/O information of 5/1 and I/O information of 5/3 are therefore saved. The response speed in the I/O history of VOL2 exceeds the threshold on 5/1. The I/O history of 5/1 is therefore saved.

The administrator may use those pieces of saved I/O information to reproduce the I/O history of 5/1 of VOL1 and the I/O history of 5/1 of VOL2 simultaneously by focusing on timeline and execute a performance simulation. Alternatively, the administrator may reproduce the I/O history of 5/3 of VOL1 (high average response speed) and the I/O history of 5/1 of VOL2 simultaneously by focusing on I/O load, to execute a performance simulation.

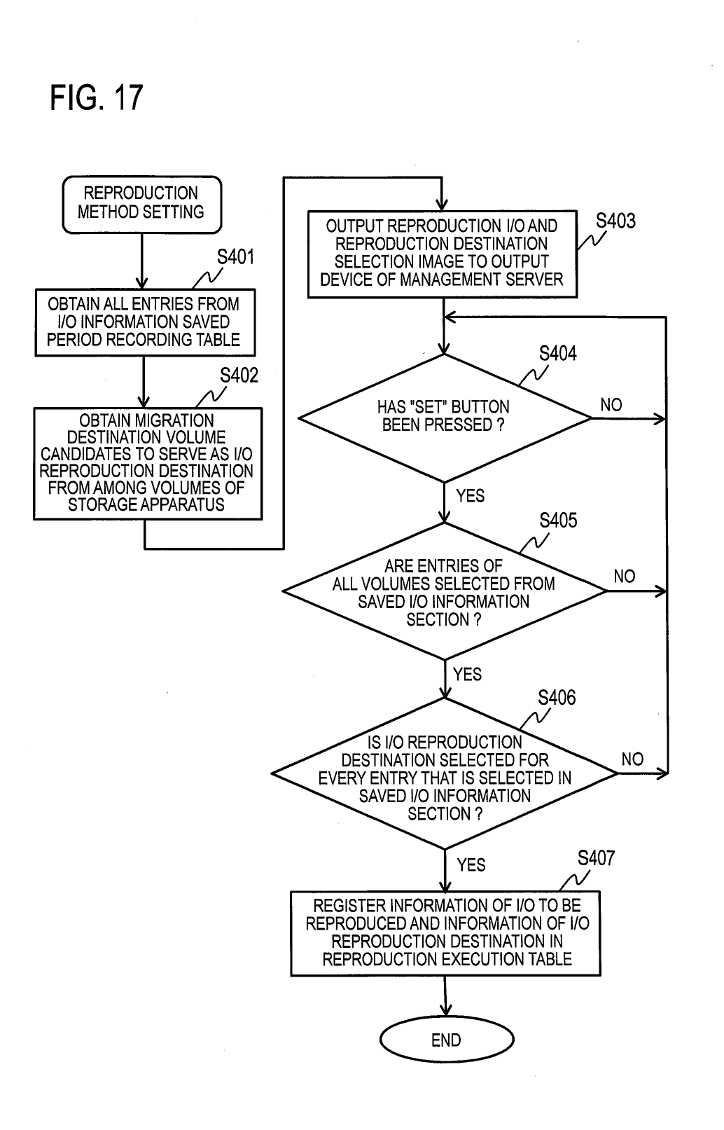

The reproduction method setting step S103 is described next with reference to FIG. 17. In the reproduction method setting step S103, an I/O history to be used in a simulation and an I/O reproduction destination volume are determined based on an input made by the administrator. FIG. 17 is a flow chart illustrating an example of the reproduction method setting step S103. The reproduction method setting program 482 executes this flow. The reproduction method setting program 482 first obtains all entries from the I/O information saved period recording table 950 (S401).

The reproduction method setting program 482 further obtains the identifiers of migration destination candidate volumes to serve as an I/O reproduction destination from among volumes of a simulation target storage apparatus (S402). For example, a simulation target storage apparatus is specified in advance by the administrator via the input device 144. In this example, the storage apparatus STG3 (120C) alone is specified as a simulation target storage apparatus.

For instance, the reproduction method setting program 482 obtains information of all volumes that can be used in the simulation from the simulation target storage apparatus STG3 (120C), and selects a volume that satisfies a predetermined simulation condition from among the volumes. The simulation condition is specified by, for example, the administrator, and may include a condition that the capacity of a migration destination candidate volume is equal to or larger than the capacity of the migration source volume, a condition that the level of performance of the migration destination candidate volume is equal to or higher than the level of performance of the migration source volume, and the like.

The reproduction method setting program 482 next generates the reproduction I/O and reproduction destination selection image 700 and outputs the image 700 to the output device 145 of the management server 140 (S403). The reproduction I/O and reproduction destination selection image 700 displays the information obtained in Step S401 in the saved I/O information section 701 and displays the information obtained in Step S402 in the I/O reproduction destination section 702.

The reproduction method setting program 482 determines whether or not the “set” button 703 has been pressed in the reproduction I/O and reproduction destination selection image 700 (S404). In the case where the result of the determination is negative (S404: NO), the reproduction method setting program 482 returns to Step S404.

In the case where the result of the determination is positive (S404: YES), the reproduction method setting program 482 determines whether or not entries of all volumes (VOL1 and VOL2 in this example) are selected from the saved I/O information section 701 (S405). In the case where the result of the determination is negative (S405: NO), the reproduction method setting program 482 returns to Step S404.

In the case where the result of the determination is positive (S405: YES), the reproduction method setting program 482 determines whether or not an I/O reproduction destination is selected from the I/O reproduction destination section 702 for every entry selected in the saved I/O information section 701 (for each of two entries in this example) (S406). In the case where the result of the determination is negative (S406: NO), the reproduction method setting program 482 returns to Step S404.

In the case where the result of the determination is positive (S406: YES), the reproduction method setting program 482 registers information on an I/O history to be reproduced and information on the I/O reproduction destination in a reproduction execution table 960 (S407).

In the above-mentioned example, I/O histories of all periods in all volumes that satisfy an I/O performance condition are obtained and displayed in the saved I/O information section 701. Only I/O histories of some selected periods may be obtained and displayed instead.

For instance, the reproduction method setting program 482 may obtain and display, for each migration source volume, only an I/O history of a period when the I/O performance is the lowest, e.g., a period where the value of the maximum response time is largest. In the case where only an I/O history of a period that satisfies a performance threshold condition first is saved as described above, the saved I/O information section 701 displays for each migration source volume only information of an I/O history of one period.

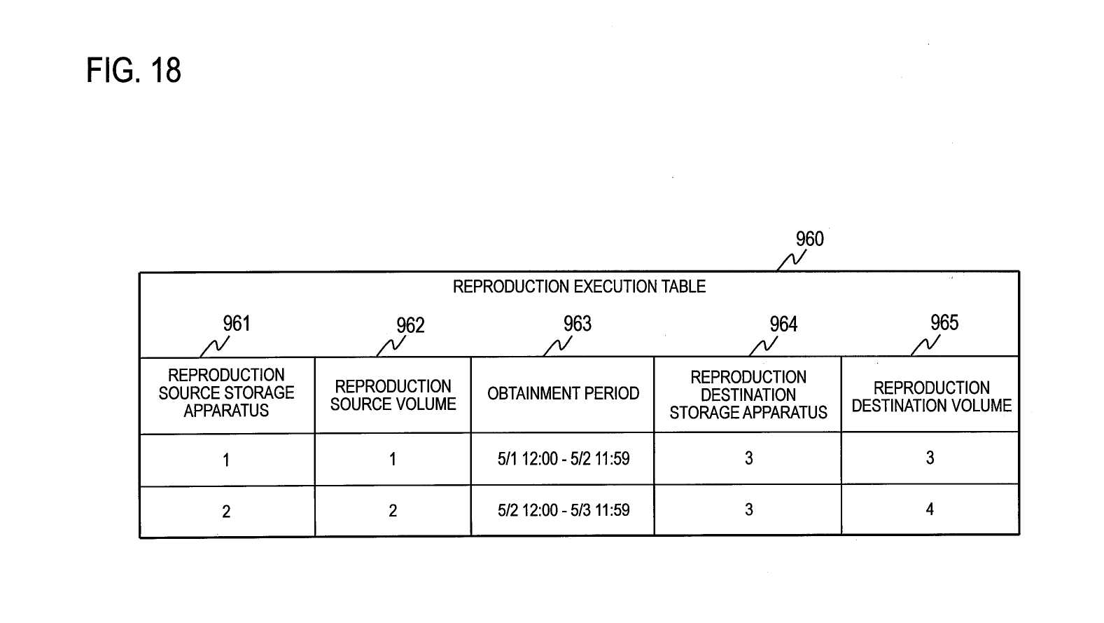

FIG. 18 illustrates a configuration example of the reproduction execution table 960. A simulation for the storage apparatus STG3 (120C) is executed in accordance with the reproduction execution table 960. The reproduction execution table 960 includes a reproduction source storage apparatus column 961, a reproduction source volume column 962, an obtainment period column 963, a reproduction destination storage apparatus column 964, and a reproduction destination volume column 965. Each entry represents a method of simulating a migration source volume.

The reproduction source storage apparatus column 961 and the reproduction source volume column 962 respectively indicate the identifier of a storage apparatus to which a migration source volume belongs and the identifier of the migration source volume. The obtainment period column 963 indicates a period in which an I/O history is obtained to be used in the simulation. The reproduction destination storage apparatus column 964 and the reproduction destination volume column 965 respectively indicate the identifier of a storage apparatus where the simulation is executed and the identifier of a volume where the simulation is executed.

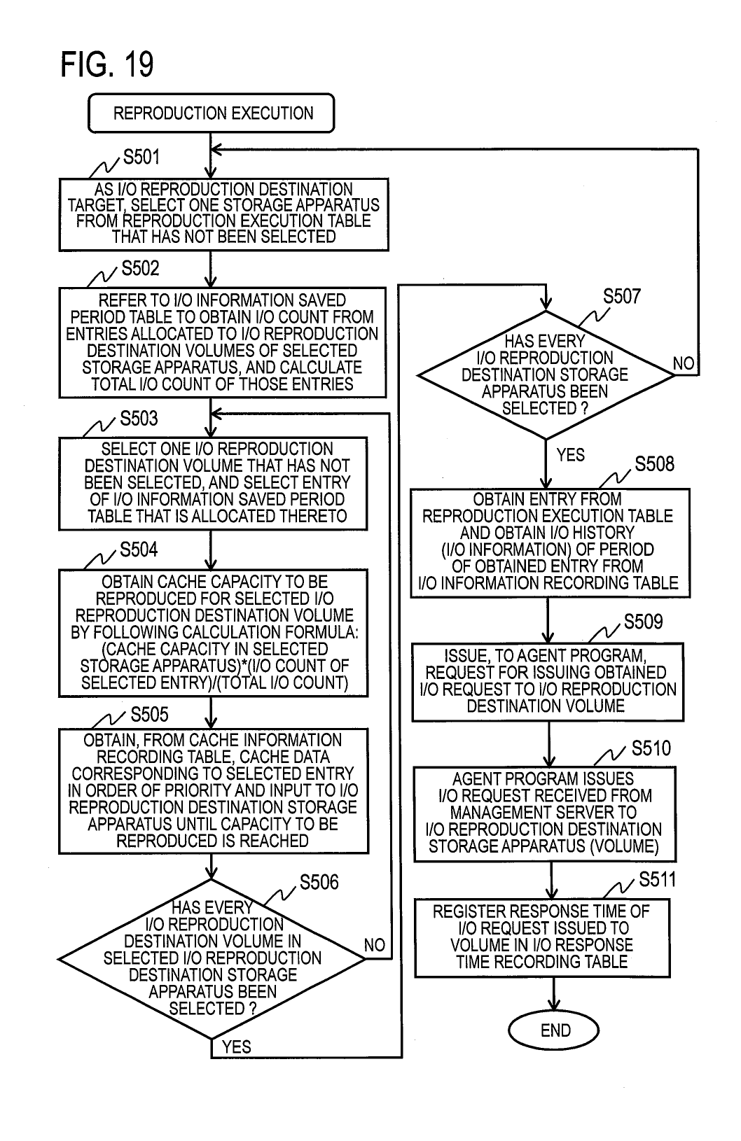

The reproduction execution step S104 is described next with reference to FIG. 19. In the reproduction execution step S104, a simulation in a reproduction destination storage apparatus is executed in accordance with the reproduction execution table 960. Specifically, the cache state and I/O history of a migration source volume are simulated. FIG. 19 is a flow chart illustrating an example of the reproduction execution step S104. The reproduction executing program 485 executes this flow (the flow includes some steps that are executed by the agent program 104).

The reproduction executing program 485 reproduces, in the storage apparatus STG3 (120C) for which the simulation is performed, a cache state based on an I/O history that is used in the simulation. The reproduction executing program 485 then sequentially issues a series of I/O requests that reflects a selected I/O history from the application server 100 to the simulation target storage apparatus STG3 (120C). The simulation-use I/O requests may instead be issued from the management server 140.

The reproduction executing program 485 first selects, from the reproduction execution table 960, as an I/O reproduction destination target, one storage apparatus that has not been selected (S501). While the storage apparatus STG3 (120C) is the only storage apparatus that can be selected in the example of FIG. 18, one of a plurality of storage apparatus is selected in the case where a simulation is executed in the plurality of storage apparatus.

The reproduction executing program 485 next refers to the I/O information saved period recording table 950 to obtain an I/O count from entries (one entry represents an I/O history of one obtainment period) allocated to I/O reproduction destination volumes of the selected storage apparatus, and to calculate the total I/O count of the entries (S502). In this example, the I/O count of an entry allocated to the reproduction destination volume VOL3 is 10,000, the I/O count of an entry allocated to the reproduction destination volume VOL4 is 30,000, and the total I/O count thereof is 40,000.

The reproduction executing program 485 next selects one I/O reproduction destination volume that has not been selected, and selects an entry of the I/O information saved period table that is allocated to the selected volume (S503). The reproduction executing program 485 obtains a cache capacity to be reproduced for the selected I/O reproduction destination volume (a cache capacity to be allocated to the simulation target volume) by using the following calculation formula (S504):

(Cache capacity in selected storage apparatus)*(I/O count of selected entry)/(total I/O count)

In the example of FIG. 8, a cache capacity of 4 GB is allocated to the application APP1 (volumes VOL3 and VOL4) in the simulation of the storage apparatus STG3 (120C). The cache capacity allocated to the reproduction destination volume VOL3 is therefore calculated as 1 GB by 4 GB*10,000/40,000, and the cache capacity allocated to the reproduction destination volume VOL4 is calculated as 3 GB by 4 GB*30,000/40,000.

The reproduction executing program 485 next obtains from the cache information recording table 930 cache data corresponding to the selected entry in descending order of priority until the capacity to be reproduced is reached, and inputs the cache data to the I/O reproduction destination storage apparatus (S505).

The reproduction executing program 485 next determines whether or not every I/O reproduction destination volume in the selected I/O reproduction destination storage apparatus has been selected (S506). In the case where the result of the determination is negative (S506: NO), the reproduction executing program 485 returns to Step S503.

In the case where the result of the determination is positive (S506: YES), the reproduction executing program 485 determines whether or not every I/O reproduction destination storage apparatus has been selected (S507). In the case where the result of the determination is negative (S507: NO), the reproduction executing program 485 returns to Step S501.

In the case where the result of the determination is positive (S507: YES), the reproduction executing program 485 obtains an entry from the reproduction execution table 960 to obtain from the I/O information recording table 940 an I/O history (I/O information) of a period of the obtained entry (S508). The reproduction executing program 485 issues, to the agent program 104 of the application server 100, a request to issue an I/O request that reflects the obtained I/O history to an I/O reproduction destination volume (S509).

The agent program 104 issues to the I/O reproduction destination storage apparatus (volume) the I/O request received from the management server 140 (S510). The agent program 104 issues a series of I/O requests to a plurality of simulation target volumes within the same period. In this example, the type, access destination addresses (including the data length), issue order, and issue interval of the simulation-use I/O requests which are issued sequentially match those in the I/O history of the migration source. Write data of a simulation-use write request may not be the same as write data in the I/O history of the migration source.

Access destination addresses of one simulation-use I/O request and another simulation-use I/O request may not match access destination addresses of one I/O request and another I/O request in the migration source I/O history. The relation between an access destination address of one simulation-use I/O request and an access destination address of another simulation-use I/O request matches the relation between an access destination address of one I/O request and an access destination address of another I/O request in the migration source I/O history. For example, the access destination address of each simulation-use I/O request may be shifted by a given value from the access destination address of the corresponding I/O request in the migration source I/O history.

The reproduction executing program 485 registers the response time of each I/O request issued to a reproduction destination volume in an I/O response time recording table 970 (S511). The I/O information outputting program 232 in the storage apparatus STG (120C) saves an I/O history at the time of the simulation, and transmits the I/O history (I/O information) of a specified volume to the reproduction executing program 485 in response to a request made by the reproduction executing program 485. The same processing may be executed by the agent program 104.

The transmitted I/O history includes a response time value of a response to each I/O request. The reproduction executing program 485 obtains information on the response time of each I/O request from the received I/O history and registers the information in the I/O response time recording table 970.

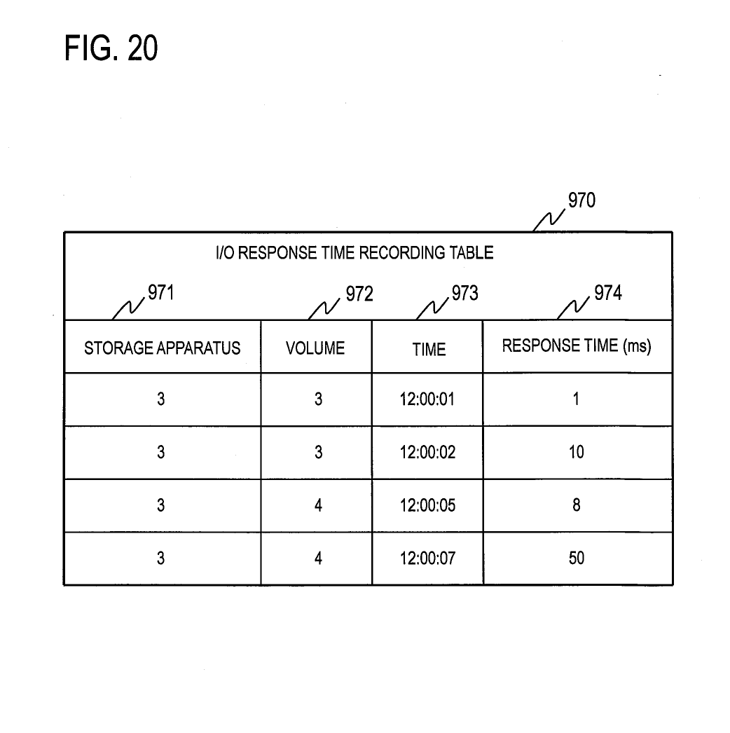

FIG. 20 illustrates a configuration example of the I/O response time recording table 970. The I/O response time recording table 970 stores for each volume the response time value of each I/O request made to the volume in a simulation. The I/O response time recording table 970 includes a storage apparatus column 971, a volume column 972, a time column 973, and a response time column 974.

The storage apparatus column 971 and the volume column 972 respectively indicate the identifier of a storage apparatus to which an I/O request has been issued and the identifier of a volume to which the I/O request has been issued. The time column 973 and the response time column 974 respectively indicate a time at which the I/O request has been issued and a response time taken to respond to the I/O request.

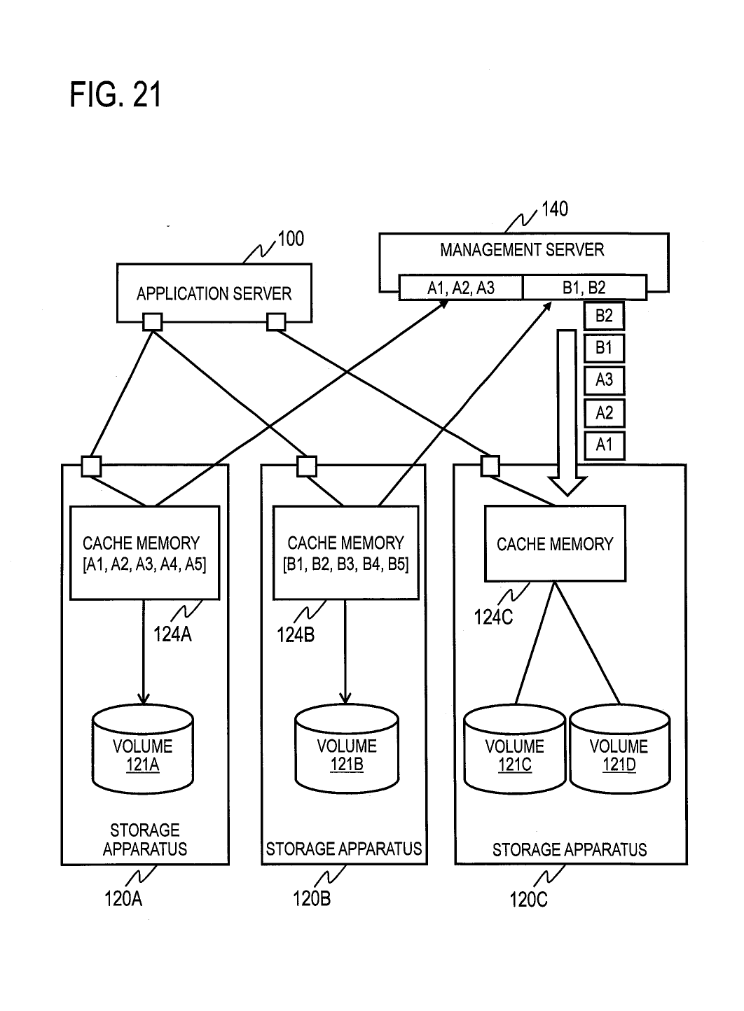

FIG. 21 is a schematic view illustrating a method of reproducing the cache state in a reproduction destination storage apparatus. The volume 121A of the storage apparatus 120A receives 3,000 I/O requests issued thereto, and the volume 121B of the storage apparatus 120B receives 2,000 I/O requests issued thereto. The cache memories 124A to 124C each have a capacity of 5.

The cache memory 124A of the storage apparatus 120A contains data A1, data A2, data A3, data A4, and data A5. The data A1 has the highest level of priority, followed by the data A2, the data A3, and the data A4, and the data A5 has the lowest level of priority.

The cache memory 124B of the storage apparatus 120B contains data B1, data B2, data B3, data B4, and data B5. The data B1 has the highest level of priority, followed by the data B2, the data B3, and the data B4, and the data B5 has the lowest level of priority.

In this case, the cache memory 124C of the storage apparatus 120C cannot store all pieces of cache data. The storage apparatus 120C therefore stores A1, A2, and A3, and B1 and B2 at a ratio of 3:2 which is the I/O count ratio of the storage apparatus 120A and the storage apparatus 120B.

As described above, the value of cache data of a simulation target volume that is prepared in a simulation target storage apparatus at the start of a simulation does not need to be the same as the value of cache data of the migration source volume at the start of an obtainment period. The intra-volume address of the prepared cache data corresponds to the intra-volume address of cache data of the migration source volume. The intra-volume address of the former and the intra-volume address of the latter match in an example, but as is the case for access destination addresses of I/O requests, may differ from each other. The intra-volume address of cache data in a simulation target storage apparatus is determined so as to match the access destination address of a simulation-use I/O request.

In the above-mentioned example, cache data is actually stored in a cache space of the simulation target storage apparatus STG3 (120C). The reproduction executing program 485 may instead change just the contents of the cache management table of the simulation target storage apparatus STG3 (120C).

In the case where the value of cache data prepared in the simulation target storage apparatus STG3 (120C) does not match the value of cache data in a migration source storage apparatus, the cache information recording table 930 may omit the data column 935.

In the above-mentioned example, cache capacities allocated to the reproduction destination volumes (VOL3 and VOL4) are determined based on the I/O count ratio of I/O histories of one obtainment cycle of the migration source volumes used in the simulation (VOL1 and VOL2). This ensures a more precise simulation in a simulation target storage apparatus where a shared cache space is used by a plurality of volumes. The management server 140 may follow other rules in determining the cache capacity ratio of VOL3 and VOL4.

For instance, the management server 140 selects, from among all pieces of cache data in VOL1 and VOL2, 4 GB of data in reverse chronological order of obtained date/time. The management server 140 may instead determine the cache capacity ratio of VOL3 and VOL4 at the start of the simulation so as to match the capacity ratio of VOL1 and VOL2.

Alternatively, the management server 140 determines the cache capacity ratio of VOL3 and VOL4 at the start of the simulation so as to match the ratio of capacities allocated to VOL1 and VOL2. A user may specify a reproduced cache capacity. The management server 140 allocates a cache capacity specified by the administrator via the input device 144 to a simulation target volume (application).

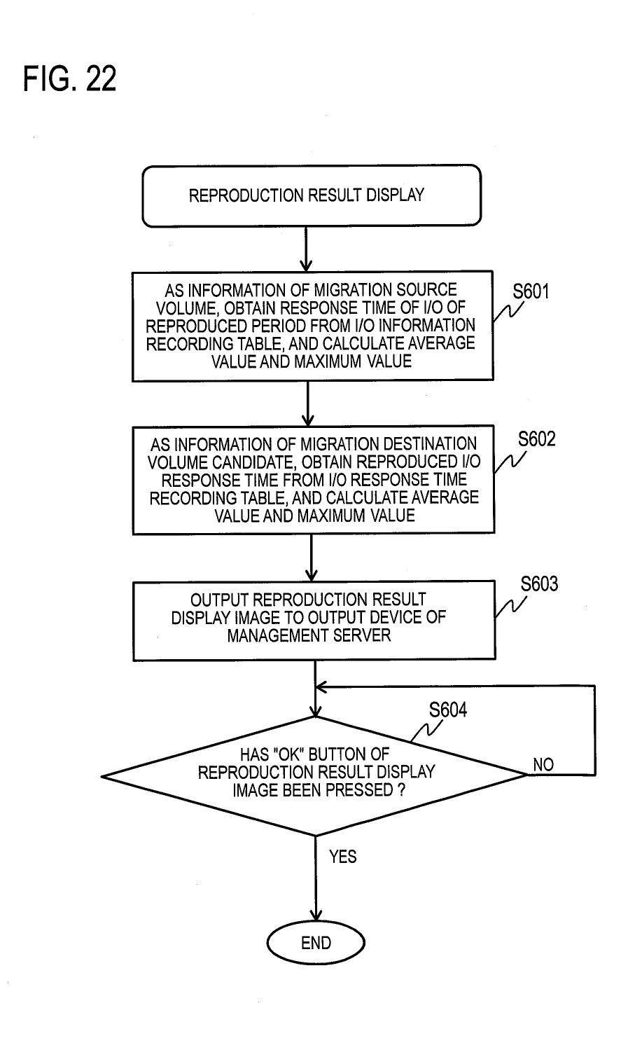

The reproduction result display step S105 is described next with reference to FIG. 22. The reproduction result display step S105 includes generating and outputting a reproduction result image which shows a simulation result. FIG. 22 is a flow chart illustrating an example of the reproduction result display step S105. The reproduction result displaying program 483 executes this flow.

The reproduction result displaying program 483 obtains, as information of the migration source volumes (VOL1 and VOL2), from the I/O information recording table 940, response time values in an I/O history of a reproduced period to calculate an average response time value and a maximum response time value (S601). The reproduction result displaying program 483 obtains, as information of migration destination candidate volumes (VOL3 and VOL4), the response time of reproduced I/O from the I/O response time recording table 970 to calculate an average response time value and a maximum response time value (S602). The reproduction result displaying program 483 generates the reproduction result display image 800, and outputs the reproduction result display image 800 to the output device 145 of the management server 140 (S603).

The reproduction result displaying program 483 determines whether or not an “OK” button has been pressed in the reproduction result display image (S604). In the case where the result of the determination is negative (S604: NO), the reproduction result displaying program 483 repeats Step S604. In the case where the result of the determination is positive (S604: YES), the reproduction result displaying program 483 ends the flow.

According to this embodiment, when migrating a volume, whether the volume to be migrated fulfills a required level of performance in a migration destination volume can be checked with precision prior to migration by simulating the response time of the simulation target volume based on the current access characteristics of an application.

This invention is applicable not only to volume migration to a new system but also to the simulation of whether or not a volume can be migrated to a different arbitrary storage apparatus, system performance measurement, application load measurement, and the like. In the case of system performance measurement, this invention makes it possible to measure system performance including the hardware performance of the migration destination by using history information indicating a specific load or I/O pattern that can be a reference as information about the I/O history of the migration source. In the case of application load measurement, this invention makes it possible to measure the load of the migration source with a specific system as a reference by giving the migration destination system a specific configuration or specific hardware.

This invention has been described in detail with reference to the accompanying drawings, but is not limited to those concrete configurations, and encompasses various modifications and equivalent configurations within the spirit of the scope of claim set forth below. For instance, some or all of the programs may be implemented by dedicated hardware. The programs can be installed in a computer via a program distributing server or a non-transient, computer-readable medium, and can be stored in a non-volatile memory device of the computer.

What is claimed is:

1. A simulation system for simulating I/O performance of a volume of a first storage apparatus in a simulation target storage apparatus, the simulation system comprising:
a memory device; and
a processor,
wherein the memory device holds:
an I/O history of a predetermined period with respect to a first migration source volume in the first storage apparatus; and
first information comprising intra-volume addresses of cache data of the first migration source volume at start of the predetermined period, and
wherein the processor is configured to:
refer to the first information to determine cache data having addresses in a migration destination volume that correspond to at least some of the intra-volume addresses of the cache data of the first migration source volume at the start, and determine the determined cache data as cache data of a first simulation target volume of the simulation target storage apparatus; and
issue simulation-use I/O requests to the first simulation target volume in accordance with the I/O history of the predetermined period.

2. The simulation system according to claim 1,
wherein the memory device further holds:
an I/O history of one period for each of a plurality of migration source volumes including the first migration source volume; and
cache information comprising intra-volume addresses of cache data of the each of the plurality of migration source volumes at start of the one period of the each of the plurality of migration source volumes, and
wherein the processor is further configured to:
for each of a plurality of simulation target volumes corresponding to the each of the plurality of migration source volumes, determine a cache capacity to be allocated to the each of the plurality of simulation target volumes;
based on the determined cache capacity and the cache information, determine intra-volume addresses of cache data to be used at start of the simulation of the plurality of simulation target volumes, out of the cache data of the each of the plurality of migration source volumes; and
issue simulation-use I/O requests respectively to the plurality of simulation target volumes in accordance with the respective I/O histories of the one period of the plurality of migration source volumes.

3. The simulation system according to claim 2, wherein the respective I/O histories of the one period of the plurality of migration source volumes satisfy a preset I/O load condition.

4. The simulation system according to claim 3, wherein the processor determines the cache capacity to be allocated to the each of the plurality of simulation target volumes based on a total cache capacity allocated to the plurality of simulation target volumes and an I/O count ratio of the each of the plurality of migration source volumes in the one period.

5. The simulation system according to claim 3, wherein the respective I/O histories of the one period of the plurality of migration source volumes include I/O histories of different periods.

6. The simulation system according to claim 2,
wherein the cache information comprises information that indicates a priority level of each piece of the cache data, and
wherein the processor determines the intra-volume addresses of the cache data to be used at the start of the simulation of the plurality of simulation target volumes, out of the respective pieces of the cache data of the plurality of migration source volumes, based on the priority level.

7. The simulation system according to claim 1, wherein the processor obtains a result of the simulation-use I/O request in terms of I/O performance of the first simulation target volume, and outputs the result to an output device.

8. A simulation method of simulating I/O performance of a volume of a first storage apparatus in a simulation target storage apparatus, the simulation method comprising:
obtaining an I/O history of a predetermined period with respect to a first migration source volume in the first storage apparatus;
obtaining first information that indicates at least intra-volume addresses of cache data of the first migration source volume at start of the predetermined period;
referring to the first information to determine cache data having addresses in a migration destination volume that correspond to at least some of the intra-volume addresses of the cache data of the first migration source volume, and determining the determined cache data as cache data of a first simulation target volume of the simulation target storage apparatus; and
issuing simulation-use I/O requests to the first simulation target volume in accordance with the I/O history of the predetermined period to measure I/O performance of the first simulation target volume.

9. The simulation method according to claim 8, further comprising:
obtaining an I/O history of one period for each of a plurality of migration source volumes including the first migration source volume;
obtaining cache information that indicates at least intra-volume addresses of cache data of the each of the plurality of migration source volumes at start of the one period of the each of the plurality of migration source volumes;
determining, for each of a plurality of simulation target volumes corresponding to the each of the plurality of migration source volumes, a cache capacity to be allocated to the each of the plurality of simulation target volumes;
determining, based on the determined cache capacity and the cache information, intra-volume addresses of cache data to be used at start of the simulation of the plurality of simulation target volumes, out of respective pieces of the cache data of the plurality of migration source volumes; and
issuing simulation-use I/O requests respectively to the plurality of simulation target volumes in accordance with the respective I/O histories of the one period of the plurality of migration source volumes.

10. The simulation method according to claim 8, wherein the respective I/O histories of the one period of the plurality of migration source volumes satisfy a preset I/O load condition.

11. The simulation method according to claim 10, wherein the cache capacity to be allocated to the each of the plurality of simulation target volumes is determined based on a total cache capacity allocated to the plurality of simulation target volumes and an I/O count ratio of the each of the plurality of migration source volumes in the one period.

12. The simulation method according to claim 10, wherein the respective I/O histories of the one period of the plurality of migration source volumes include I/O histories of different periods.

13. The simulation method according to claim 9,
wherein the cache information comprises information that indicates a priority level of each piece of the cache data, and
wherein the intra-volume addresses of the cache data to be used in the simulation of the plurality of simulation target volumes are determined, out of the respective pieces of the cache data of the plurality of migration source volumes, based on the priority level.

14. The simulation method according to claim 8, further comprising obtaining a result of the simulation-use I/O request in terms of the I/O performance of the first simulation target volume, and presenting the result on an output device.
